(19) United States
(12) Patent Application Publication
(10) Pub. No.: US 2006/0046853 A1
(43) Pub. Date: Mar. 2, 2006

(54) Off-site casino play

(76) Inventor: Gerald R. Black, Southfield, MI (US)

Correspondence Address: Gerald R. Black, Suite 67A, 30320 Southfield Road, Southfield, MI, 48076, US

(21) Appl. No.: 10/930,246

(22) Filed: Sep. 1, 2004

(51) Int. Cl. G06F 17/00; G06F 19/00

(52) U.S. Cl. 463/42

(57) ABSTRACT

The system enables an off-site player having a key-card or other credit medium to enjoy quality play at any game within the casino complex, at any time, and from any location. The system enables the off-site player to select any player in the casino and wager on the outcome of the on-site player play from a remote location. In addition, in games such as craps and roulette, the off-site player has the option of wagering on the selected player or placing a direct wager on the outcome of the next gaming unit. The system includes a live gaming site, a data capture device and a gaming processor for enabling play from an off-site terminal.

### FIELD OF USE

The gaming system of the present invention involves resort and hotel casinos as well as stand-alone casinos and automated play of conventional gaming activities, such as roulette, craps, KENO, blackjack, and poker. More particularly, the gaming system involves improved play and enable a player to wager on the outcome of a game in real time from a remote location.

### BACKGROUND OF THE INVENTION

Casinos monitor the play of table gaming activities with mirrors and cameras recording twenty-four hours each day looking for dealer errors, player cheating, player use of systems, or any other irregularities. Also, pit crews constantly monitor play.

While casinos have means to enable players to wager on horse races in various racetracks around the country and the world in real time, such a system is not available for other live play in the casino.

U.S. Pat. No. 5,326,104 (Pease et at.) and U.S. Pat. No. 5,340,119 (Goldfarb) each disclose an automated system for casino gambling where an off-site player is able to play KENO from a remote location. U.S. Pat. No. 5,566,327 (Sehr) discloses an information management system for use in a theme park using smart cards and biometric identification. PCT Application 97/05736 (Black and Dykman) discloses a system whereby the casino is able to acquire all information relative to live games in the casino (such as blackjack, roulette, and craps) by use of scanners, house cards, and interactive monitors. The casino is able to ascertain the identity of each player, how much each player is wagering, each player's gaming decisions, and the value of the gaming materials.

However, many people are uncomfortable in a crowded gaming casino, particularly, alone during late hours.

What is needed is a gaming system that will enable a casino to increase the gaming activity throughout the casino without adding additional floor personnel (dealers, security guards, pit crew, etc.); that enables fully automated play of all gambling activities within a casino in a real time from anywhere within the complex, including but not limited to restaurants and lounges, luxury suites, and guest rooms; that will enable players to participate in quality off-site play; that will enable the off-site player to bet indirectly by selecting an active player and piggyback onto the player's play of the gaming unit; that will enable the off-site player to wager directly on live play in real time in games such as craps and roulette within the casino; and that will enable an off-site player to bet on live action within the casino from an Intranet or an Internet terminal.

### SUMMARY OF THE INVENTION

The system of the present invention includes a live gaming site, a data capture device, a gaming processor, and an off-site terminal. The system enables any off-site player to enjoy quality play and to play any game within the casino complex, at any time, and from any remote location. The system of the present invention enables the off-site player to select any player in the casino and wager on the outcome of on-site gaming activity from a remote location. The off-site player has the additional option in games such as craps and roulette to place a direct wager on the outcome of the next gaming unit.

The gaming site includes a plurality of playing tables disposed within the casino. A blackjack game comprises a dealer and a plurality of players. For craps, each table includes a plurality of playing positions about the craps table, a casino game manager, and a player designated as the roller.

The gaming processor has direct access to gaming activity data from the gaming site relative to the specific values of gaming materials (cards, dice, roulette ball and wheel, etc.) relative to a gaming unit and historical information, relative to the outcome and values of the gaming materials per each gaming unit. In one preferred embodiment of the gaming system of the present invention, a unique credit medium uses a biometric identifier, such as a fingerprint, which insures that the player making the wager is the player to whom the card is issued. The biometric identifier prevents any unauthorized use and enables the offsite player to use the card anywhere. Hence, the credit medium is of no value to third parties and is completely secure from theft or being lost. The credit medium is assigned to each person upon registration.

The off-site player has access to information in the gaming processor relative to historical and statistical information regarding previous gaming activity. The off-site playing terminal enables additional wagers to be placed from a remote location, piggybacking onto the play at individual playing positions at the on-site game (indirect play). The terminal keypad resembles an actual on-site player station for games such as craps or roulette, enabling wagering and direct play on the values of the gaming materials relative in real time.

The system of the present invention can be used anywhere, including a restaurant, a lounge, a suite or hotel room, a racetrack, an arcade, a swimming pool. The quality of play for the off-site playing option is at least comparable to the quality of on-site play, and offers gaming options not available to the on-site player. In on-site play, a player will often be in a losing streak at a table and rather than leaving the table, fighting the crowds in an environment filled with people smoking and drinking, and finding a position at another table, will decide to ride out the streak at the current table. The off-site player is able to move from player position to player position, from table to table, and from game to game without leaving the off-site player station.

The off-site gaming system of the present invention includes a gaming processor that collects all information relative to the casino games. Such information includes the value of the gaming materials in each gaming unit (such as cards or dice), a history of winners and losers at the player positions at the tables, and in blackjack all information relative to the dealer's card values.

PCT Application 97/05736 (Black and Dykman) discloses such a system whereby in blackjack play, for example, the casino uses an optical scanner positioned within each card tray to read the value of the gaming materials, the cards that are dealt in the gaming unit. The players use key-cards rather than cash or chips, and the players use an interactive monitor to enter gaming decisions. This system serves as a platform for the system of the present invention to provide quality off-site play.

A combination of sensors mounted on and in the table in combination with the cameras located above the playing tables enables such information to be collected. The sensors may include various combinations of optical scanners located at the card racks which read playing cards, optical scanners located at each player station and dealer station to read cards retained by each player and the dealer, player and dealer keypads mounted within the tables, card readers mounted adjacent to each keypad for reading the key-cards, microphones located adjacent to each keypad or mounted onto each player or mounted onto the dealer.

The use of a speaker-microphone mounted on the blouse or shirt of the dealer, enables the dealer to narrate the play of the gaming unit, which narration is used by speech recognition to enable the computer to collect and process gaming information. For example:
Player 1 is holding 12 and draws one card;
Player 2 is holding 20 and sticks;
Player 3 has a blackjack;
The dealer is holding 16, draws a 7 and busts.
Player 1 wins, player 2 wins and player 3 wins and is paid 1.5 times the bet.

Also, a narrating dealer can be used instead of the interactive monitor keypad. Preferably, the narrating dealer is used in combination with the keypad, whereas the keypad is greatly simplified to include the card reader, a card exit button, an up and down button enabling the player to increase and decrease his bet, and a display of the player's current wager and the available credit balance.

While the principles of the present invention are applicable to all games played within a casino (such as roulette, craps, KENO, poker), blackjack will hereafter be used for purposes of illustration only. The off-site player inputs relevant information (wager amount and gaming decisions) into the computer through a keypad disposed relative to the playing table. At the beginning of each hand, the player digitally selects the wager amount by use of the keypad. Once play begins, the dealer freezes all wagers by use of the dealer's keypad. At the end of each hand the off-site player is credited or debited according to the results of the game and the amount of the wager.

For a more complete understanding of the off-site gaming system of the present invention, reference is made to the following detailed description and accompanying drawings in which the presently preferred embodiments of the invention are shown by way of example. As the invention may be embodied in many forms without departing from spirit of essential characteristics thereof, it is expressly understood that the drawings are for purposes of illustration and description only, and are not intended as a definition of the limits of the invention. Throughout the description, like reference numbers refer to the same component throughout the several views.

### BRIEF DESCRIPTION OF THE DRAWINGS

FIG. 1A is a functional block diagram disclosing an embodiment of the gaming system for a hotel/casino involving off-site reservations, on-site registration, guest room access, guest account activity on-site, and guest checkout;

FIG. 1B is a functional block diagram disclosing another embodiment of the gaming system for a stand-alone casino involving off-site registration through third parties, on-site registration, entry for pre-registered players, departure, and remote card usage;

FIG. 2A is a schematic view showing a blackjack table with six player stations each having a keypad, and the card rack relative to the table;

FIG. 2B is an exploded side elevational view of the optical scanner relative to the card rack of FIG. 2A;

FIG. 2C is an overhead elevational view of optical scanners disposed at each of the six player stations, and another optical scanner in the dealer station;

FIG. 3 is a schematic representation of the system of FIG. 1A, showing general interconnections between the hotel/resort computer, the casino computer, and individual computers for each separate casino function;

FIG. 4 is a discloses a key-card, having an electronic room key disposed on along one edge, and a credit medium disposed along the opposing edge;

FIG. 5 discloses a simplified block diagram of the gaming system and the cooperative engagement between the credit medium and the player station through the casino computer;

FIG. 6A through 6G are seven pages of a flowchart showing an logic sequence for a blackjack game that is applicable to the off-site gaming system of the present invention;

FIG. 7A through 7D shows a simplified logic diagram for playing a roulette game that is applicable to the off-site gaming system of the present invention;

FIG. 8A is an exploded detail view of a first preferred embodiment of an interactive monitor and credit medium reader in the player station for playing blackjack;

FIG. 8B is an exploded detail view of a second preferred embodiment of a simplified interactive monitor and credit medium reader in the player station for playing blackjack;

FIG. 9A is an exploded detail view of an interactive monitor and credit medium reader in the player station for playing roulette;

FIG. 9B is an exploded detail view of an interactive monitor and credit medium reader in the player station for playing craps;

FIG. 10 is a preferred embodiment shown in FIGS. 4 and 5 disclosing the functional block diagram and interrelationship of the various elements of the gaming system;

FIG. 11 is a preferred embodiment of a schematic flowchart disclosing the program logic for enabling the guest to use the security apparatus as a guest room key to gain access to his room;

FIG. 12 is a preferred embodiment of a functional block diagram of a guest room key security system for use with the security apparatus of FIG. 4;

FIG. 13 is a preferred embodiment of a logic diagram for on-site play of craps in a gambling casino relating to the present invention;

FIG. 14 is a preferred embodiment of a logic diagram for an off-site player playing craps, the off-site player selecting an on-site player and wagering on the outcome of the on-site player in the gaming unit (indirect play);

FIG. 15 is a preferred embodiment of a logic diagram for an off-site player playing blackjack and wagering on the outcome of an on-site player in the gaming unit (indirect play);

FIG. 16 is a depiction of an off-site terminal and player station for the casino gambling system of the present invention;

FIG. 17A is a block diagram of the casino gambling system of the present invention;

FIG. 17B is a hardware schematic of the main facility network including the off-site casino gambling system of FIG. 17A;

FIG. 17C is a hardware schematic of a typical gaming system for the play of blackjack for the casino gambling system of FIG. 17B;

FIG. 17D is a hardware schematic of a local off-site play network for the casino gambling system of FIG. 17B;

FIG. 17E is a block diagram of remote off-site play network accessed through leased lines or satellite communications for the casino gambling system of FIG. 17B;;

FIGS. 18A through E disclose a simplified preferred embodiment of the off-site gaming system of the present invention, disclosing a series of screens viewed by the off-site player for blackjack play with prompts enabling selection of one or more wagers on live on-site gaming activity;

FIG. 19 shows the first screen of an off-site play system of the present invention for blackjack play with data streams of information for the past five hands;

FIG. 20A shows the second screen of an off-site play system of FIG. 19, as an exploded view of the selected table with data streams of player information for the past five hands of the blackjack game before any cards are dealt to the on-site players;

FIG. 20B shows the second screen of an off-site play system of FIG. 20A, as an exploded view of the selected table with data streams of player information for the past five hands of the blackjack game after a first card has been dealt (face-up) to each the on-site players;

FIG. 20C shows the second screen of an off-site play system of FIG. 20A, as an exploded view of the selected table with data streams of player information for the past five hands after the second card has been dealt (face-up) to each the on-site players, and play has begun;

FIG. 21A discloses a first preferred embodiment of the off-site play system of the present invention with the datastreams of the results for each player for the past five games in the blackjack game, and various betting options with a touch-sensitive screen for the off-site player;

FIG. 21B discloses a second preferred embodiment of the off-site play system of the present invention with the datastreams of the results for each player for the past five games in the blackjack game, and various betting options with a touch-sensitive screen for the off-site player to select gaming results for the dealer's cards, such playing options not being available to on-site players;

FIG. 21C discloses a first preferred embodiment of the off-site play system of the present invention with the datastreams of the results for each player for the past five games, and various betting options with a touch-sensitive screen for the off-site player to select various gaming results for the on-site players and/or the dealer;

FIG. 22 is a preferred embodiment of a simplified logic diagram for an on-site player playing blackjack, the on-site player using basic blackjack strategy based upon probability tables, enabling piggyback play by an off-site player;

FIG. 23 is a preferred embodiment of a logic diagram for an off-site player playing blackjack, the off-site player selecting an on-site player and wagering on the outcome of the on-site player in the gaming unit (indirect play);

FIGS. 24A, 24B, and 24C disclose basic strategy for blackjack play based upon probability tables, which would govern the playing decision of the on-site players; and

FIG. 25 discloses a preferred embodiment for the off-site gaming system of the present invention, depicting a simplified viewing screen for an off-site player for piggyback play for slot machines, showing payouts for each machine over the past 3 hours, and the amount of money deposited in each machine during that time (in brackets).

### DETAILED DESCRIPTION OF THE INVENTION

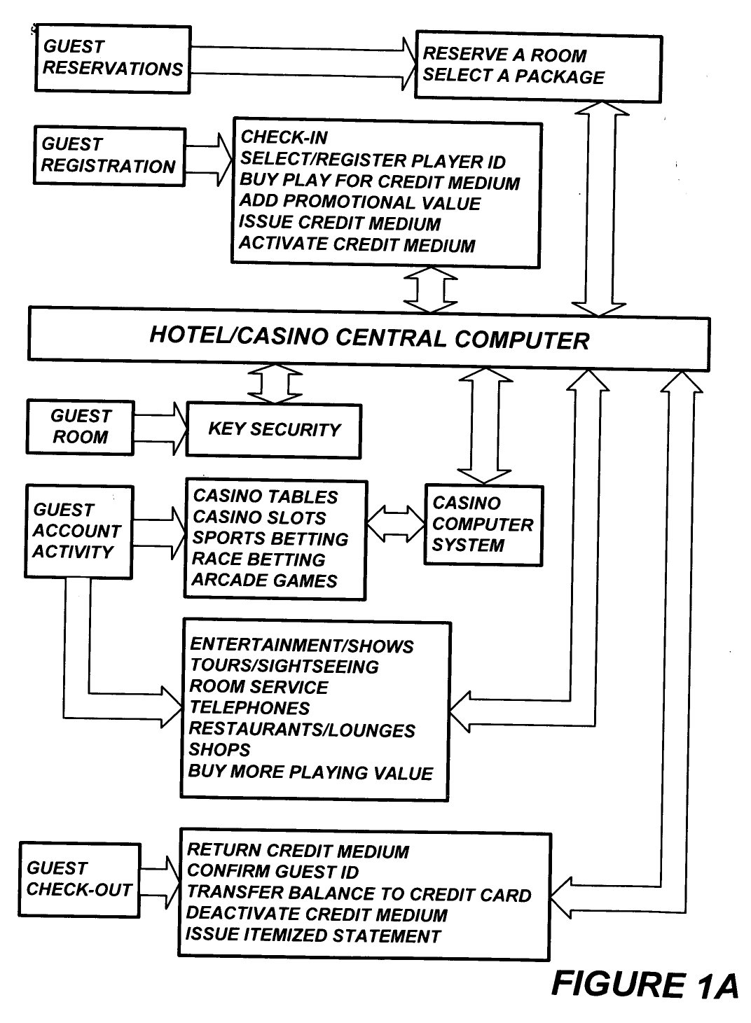

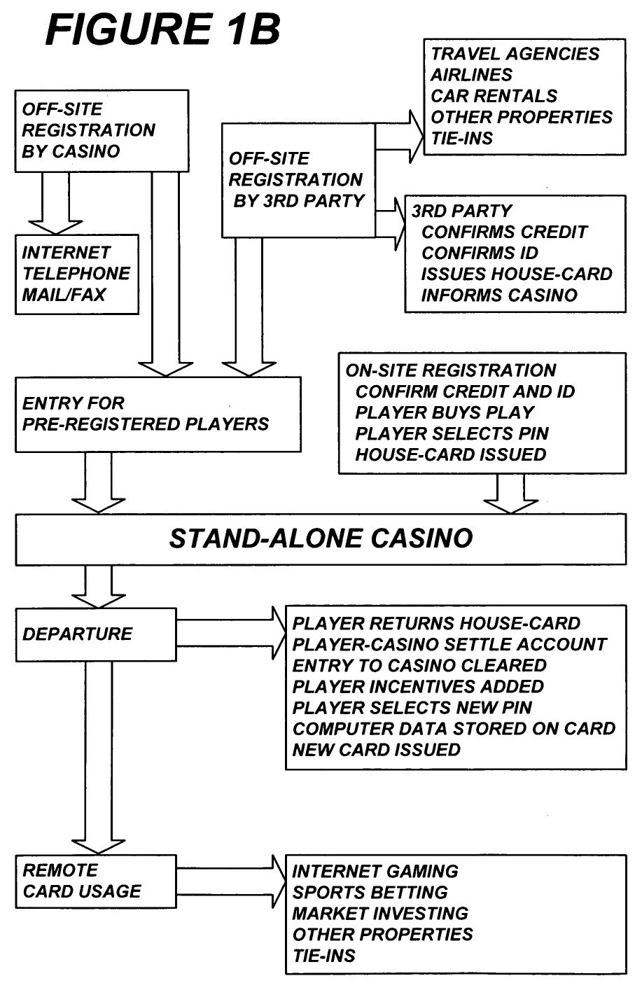

FIG. 1A discloses a hotel central computer system and a casino computer system for use with a plurality of blackjack tables, roulette tables, and slot machines. The system is for use in resort hotels and in casinos for on-site play, local off-site play, and remote off-site play. The system can be useful in all amenities associated with large resort hotels, including casino gambling (machines and tables), sports betting, room service, all hotel telephones, restaurants, lounges, entertainment and shows, arcade games, hotel shops, tour packages, and the like.

FIG. 1B discloses a similar system for use in a casino that is not associated with a hotel or resort (a stand-alone casino). A functional block diagram is shown, including off-site registration by third parties, on-site registration, entry for pre-registered players, departure, and remote card usage. In a stand-alone casino, players are encouraged to register off-site in cooperation with third parties, such as travel agents, airlines, car rentals, hotel chains, and the like. The third party confirms player identification and issues the player a credit medium 20 off-site. The credit medium 20 enables the player to enter the casino. Entry into the casino is denied if there is any question concerning the validity of the credit medium 20. All persons without a credit medium 20 and all persons with invalid off-site registration must complete registration on-site. The registration for a player in a hotel or resort casino that is not staying on-site is similar to registration for a stand-alone casino registration. The player can either register off-site through a pre-authorized third party or on-site.

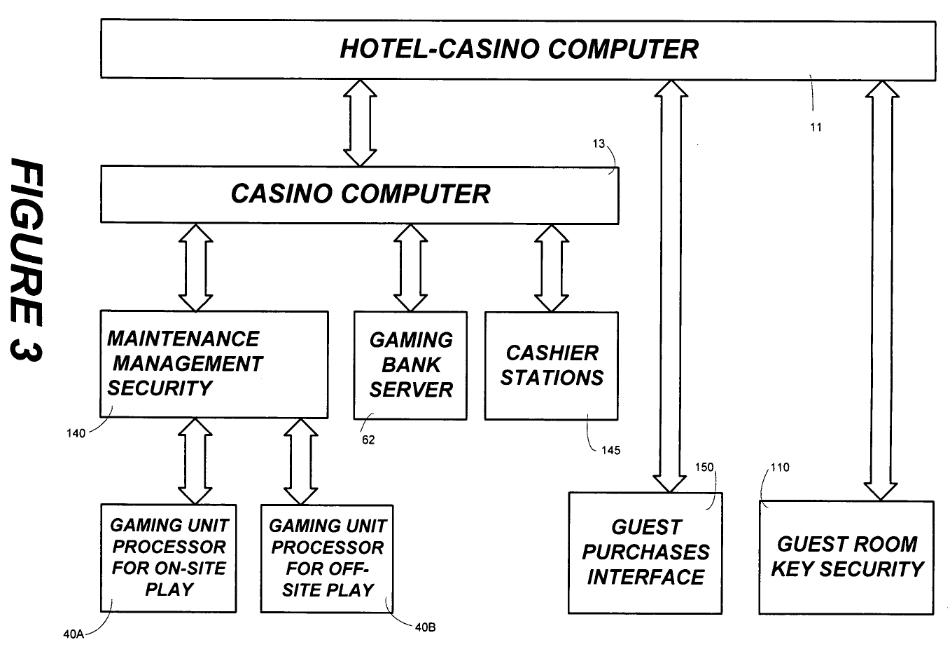

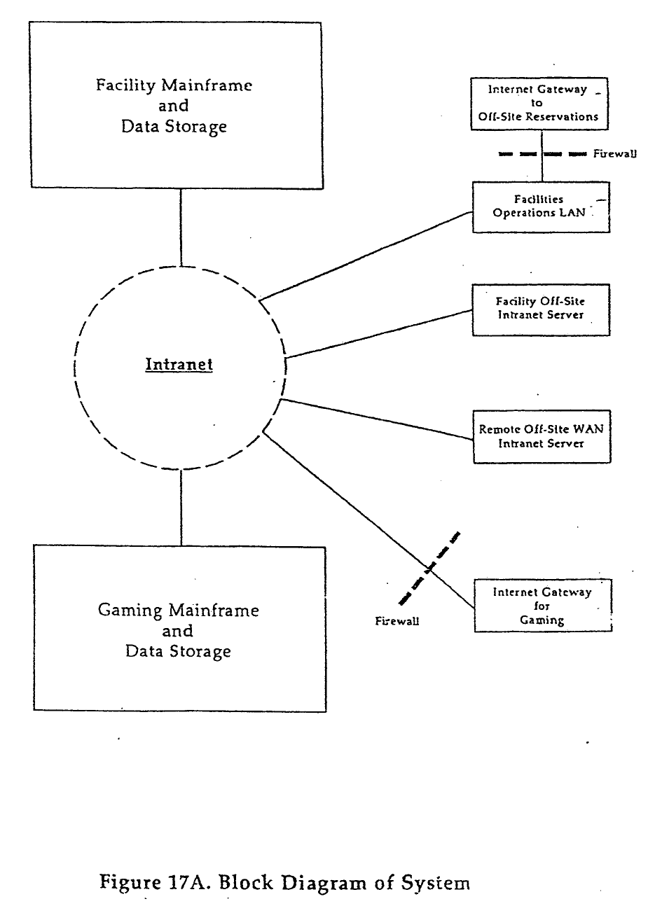

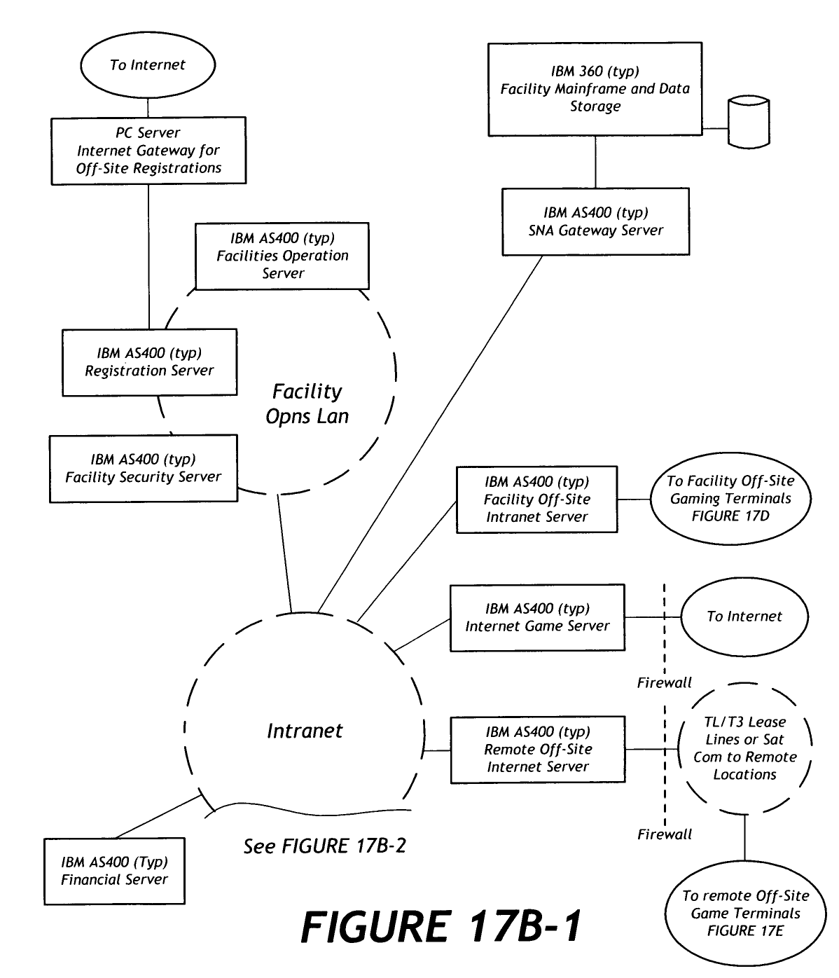

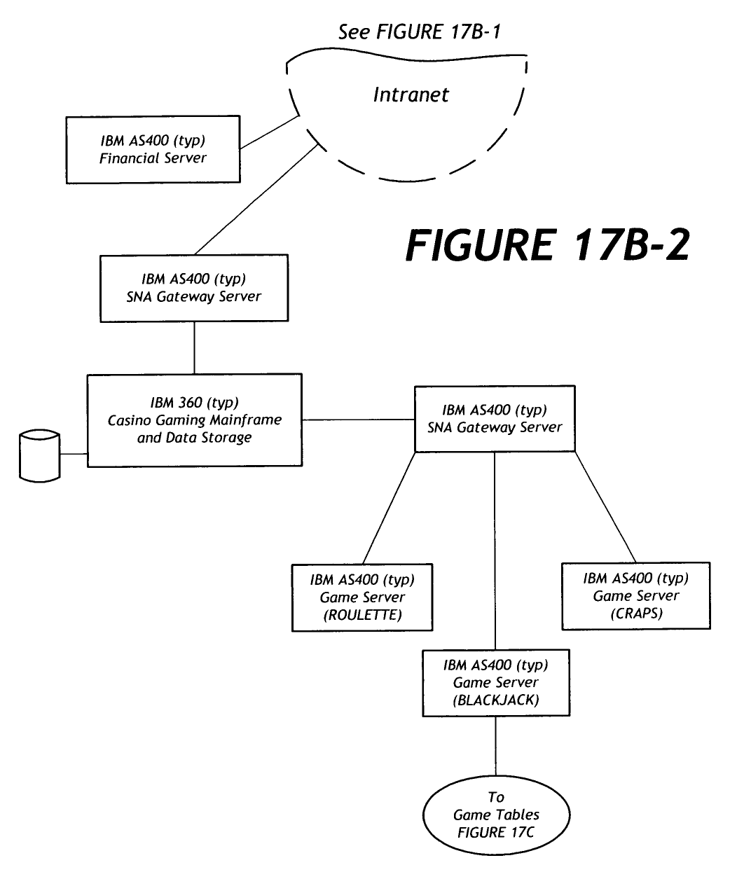

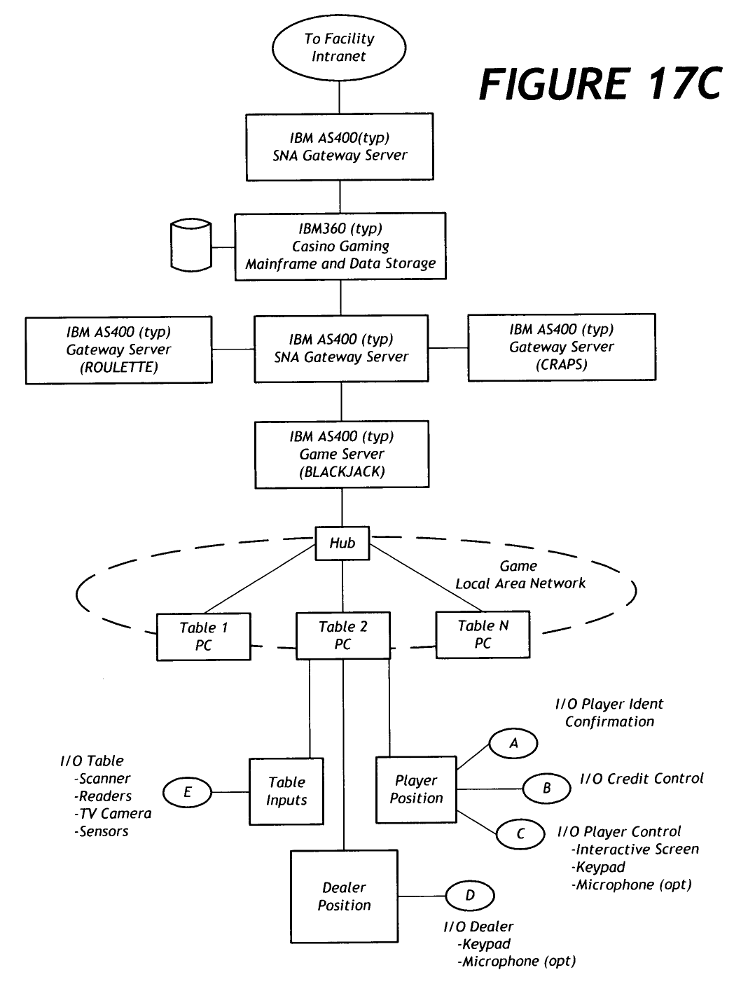

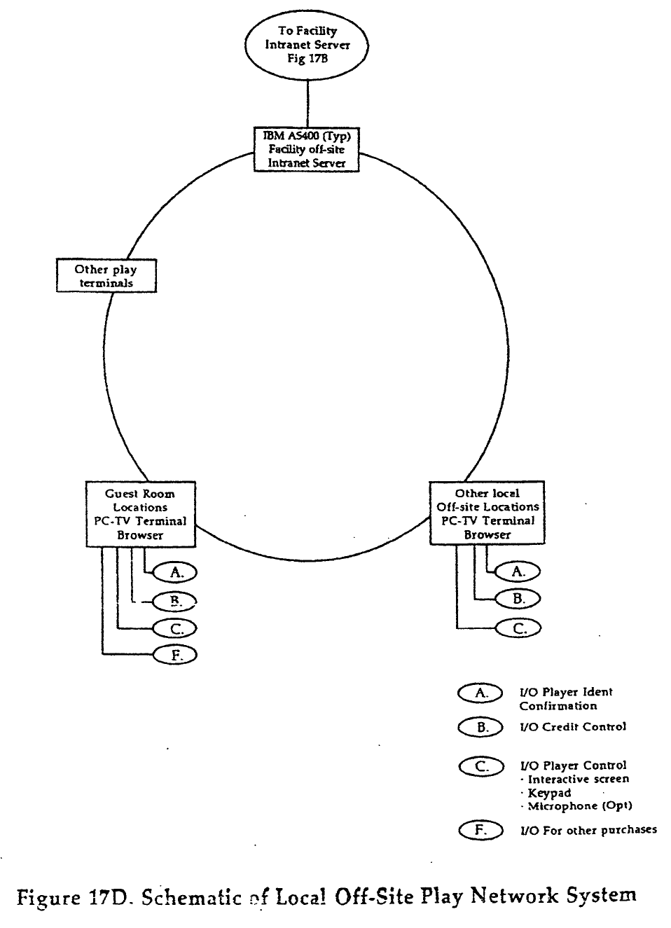

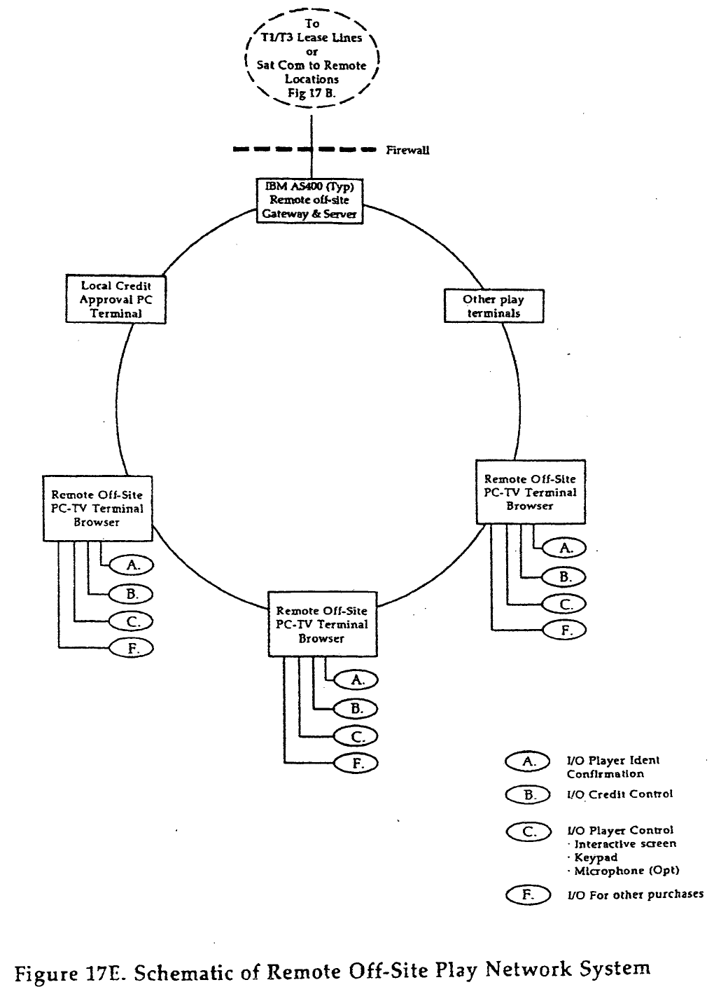

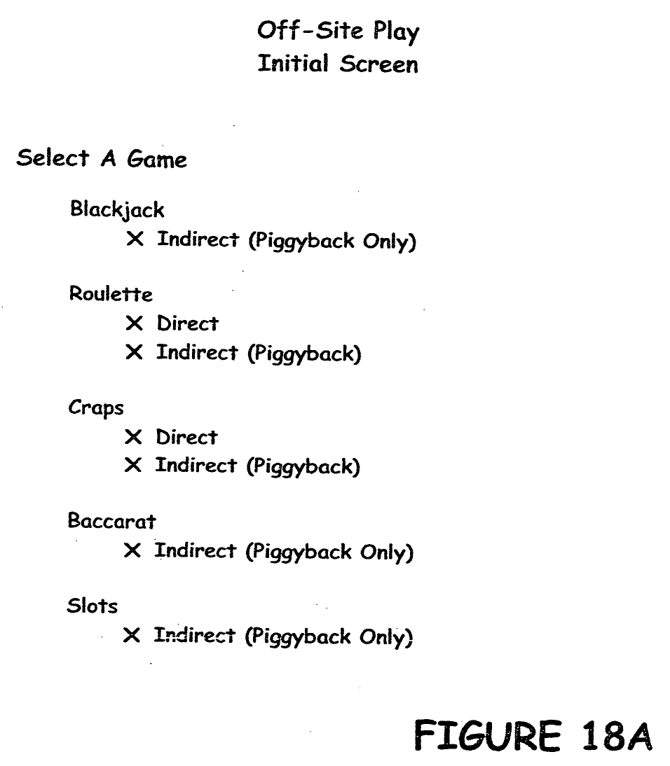

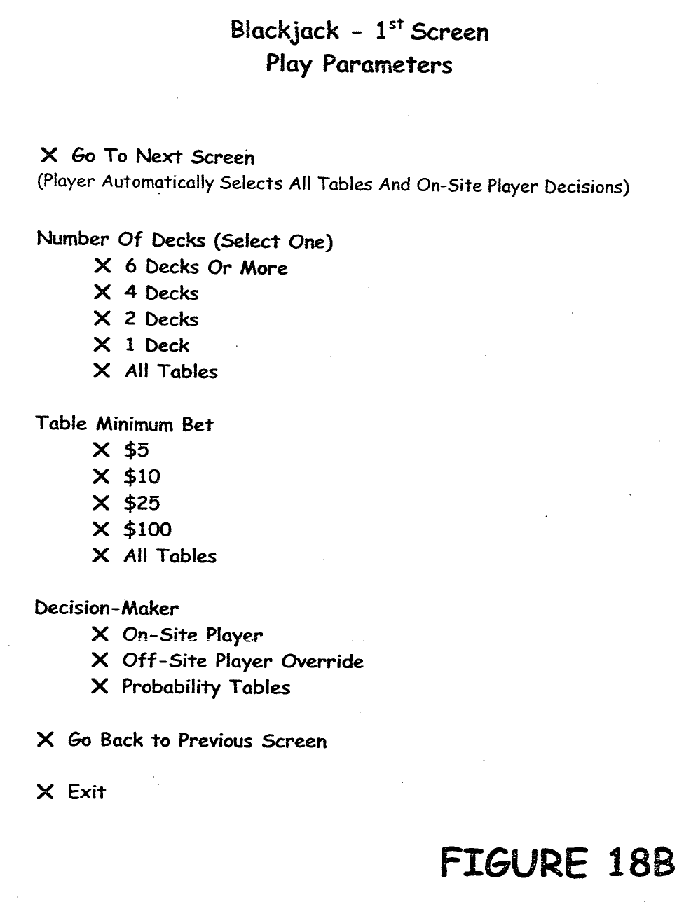

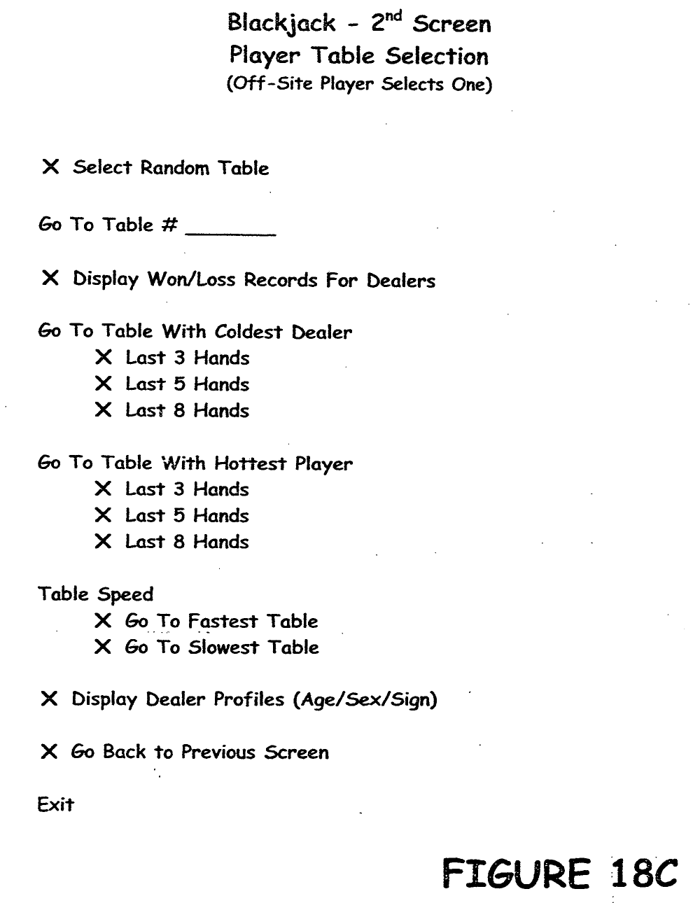

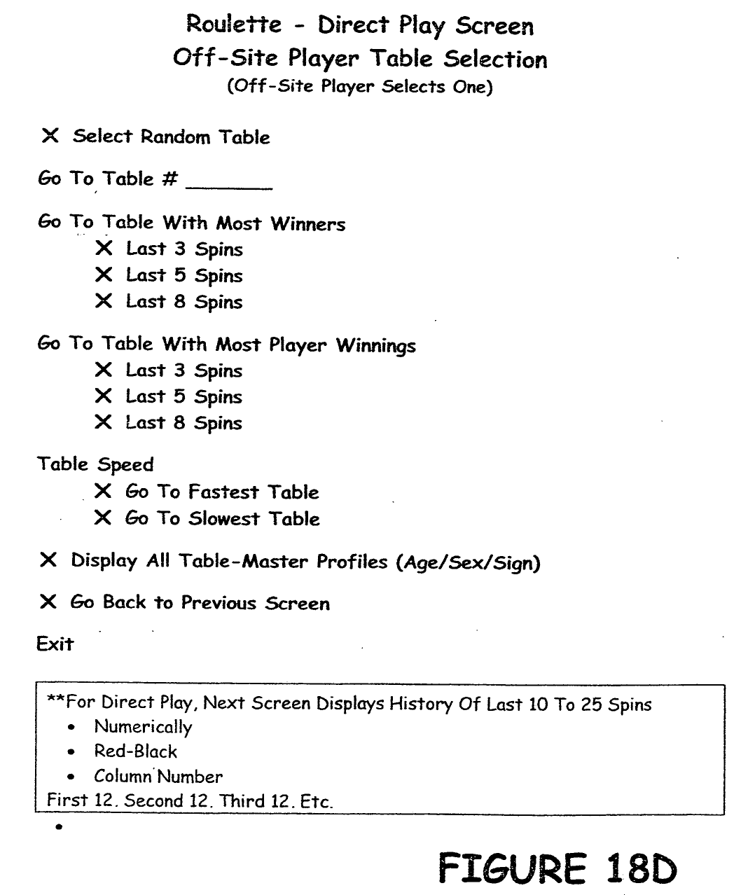

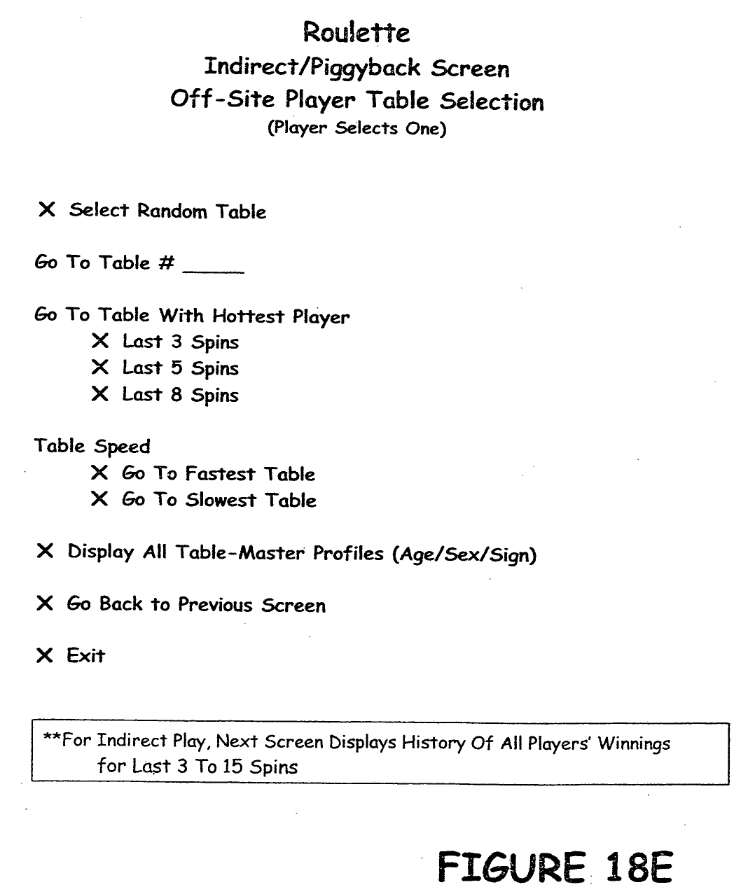

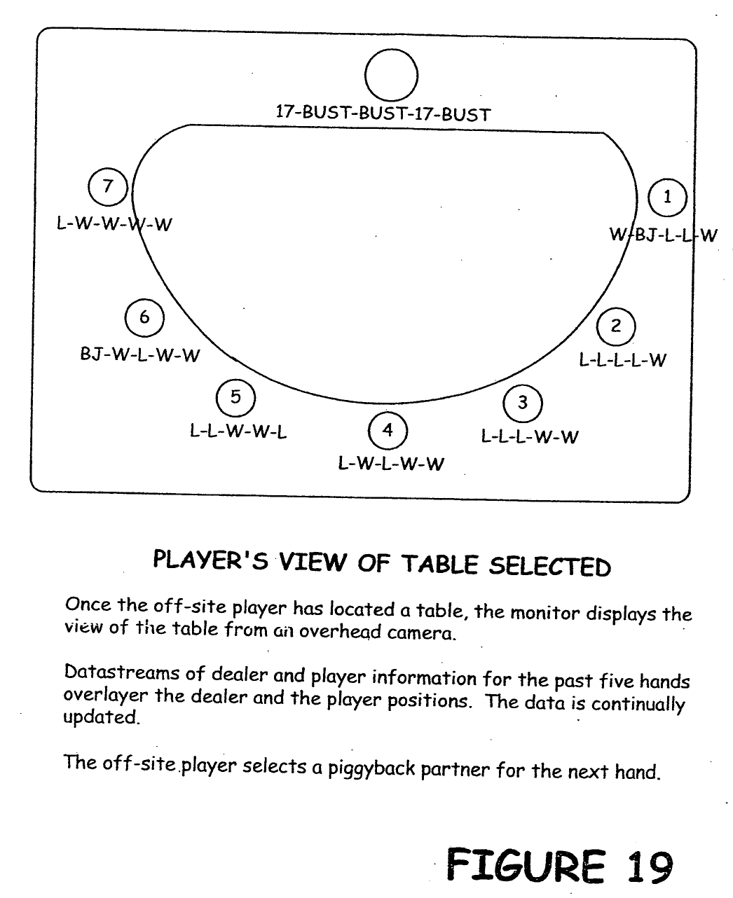

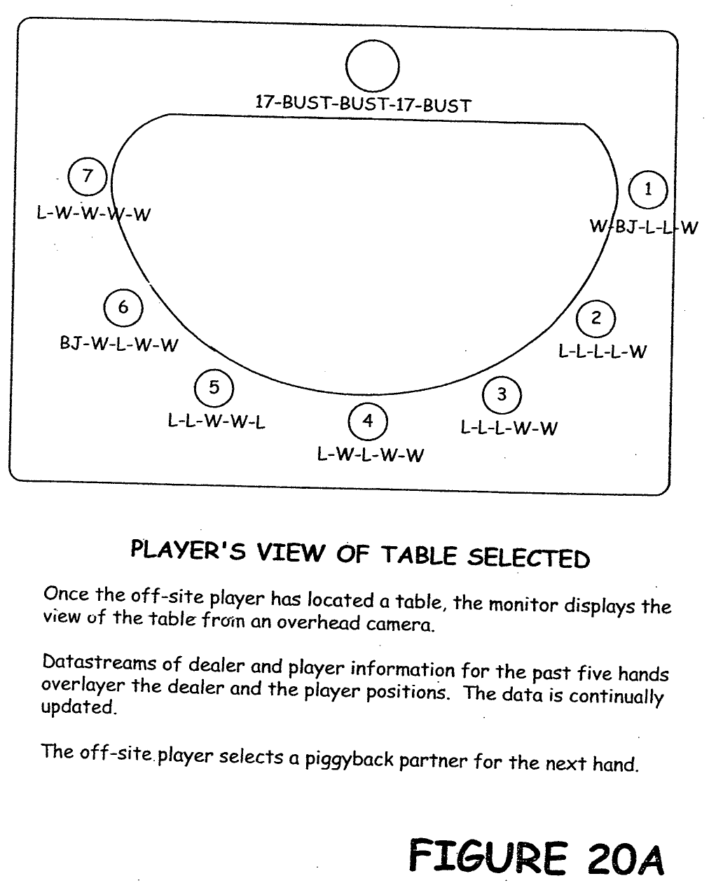

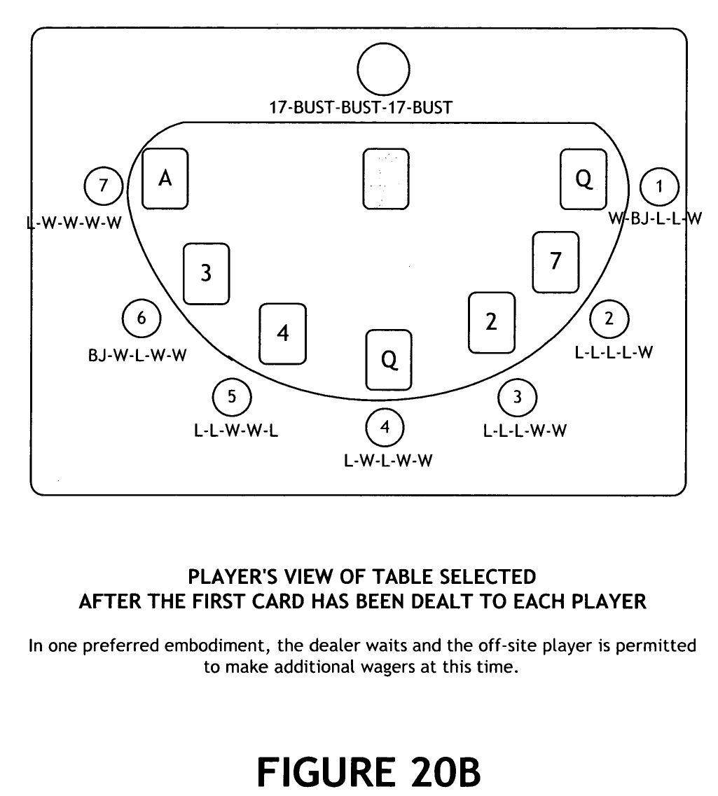

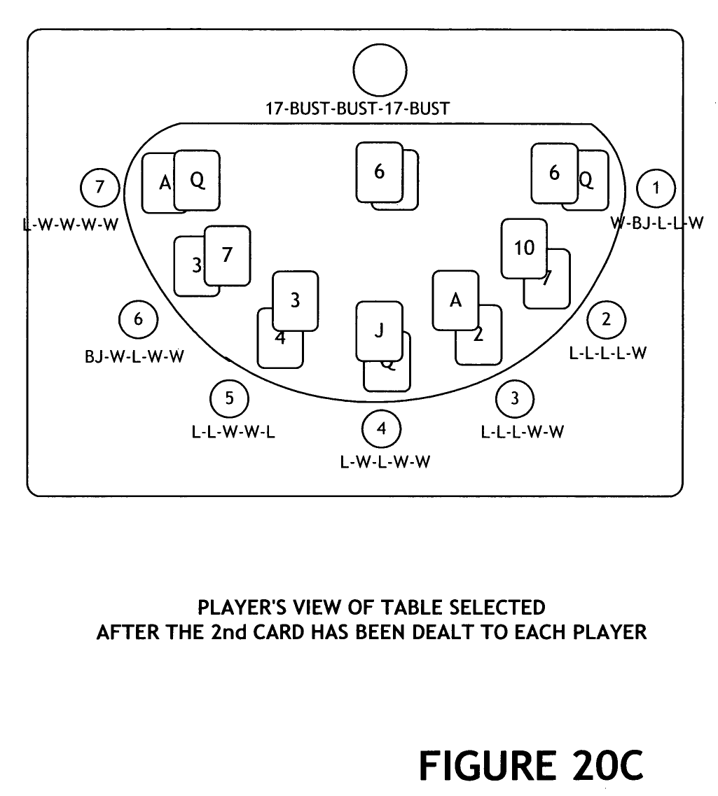

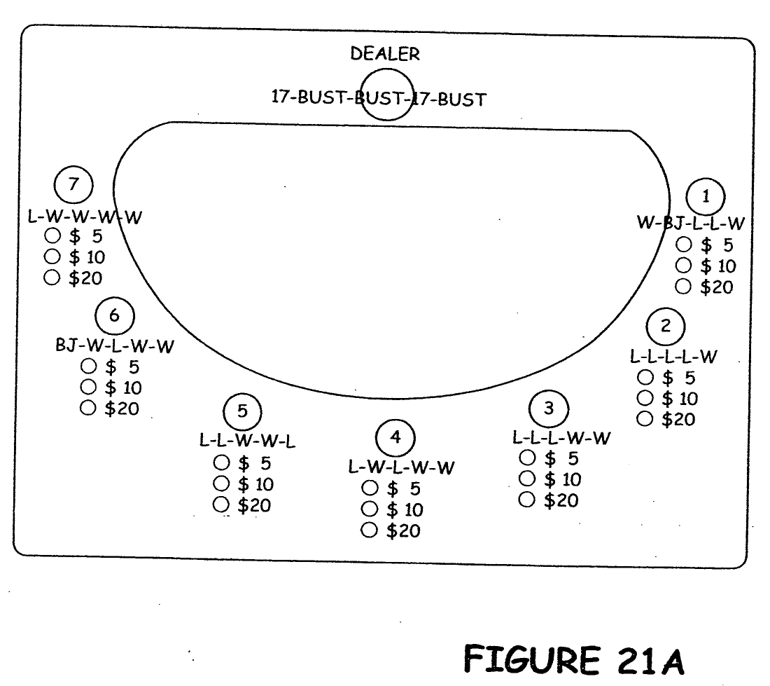

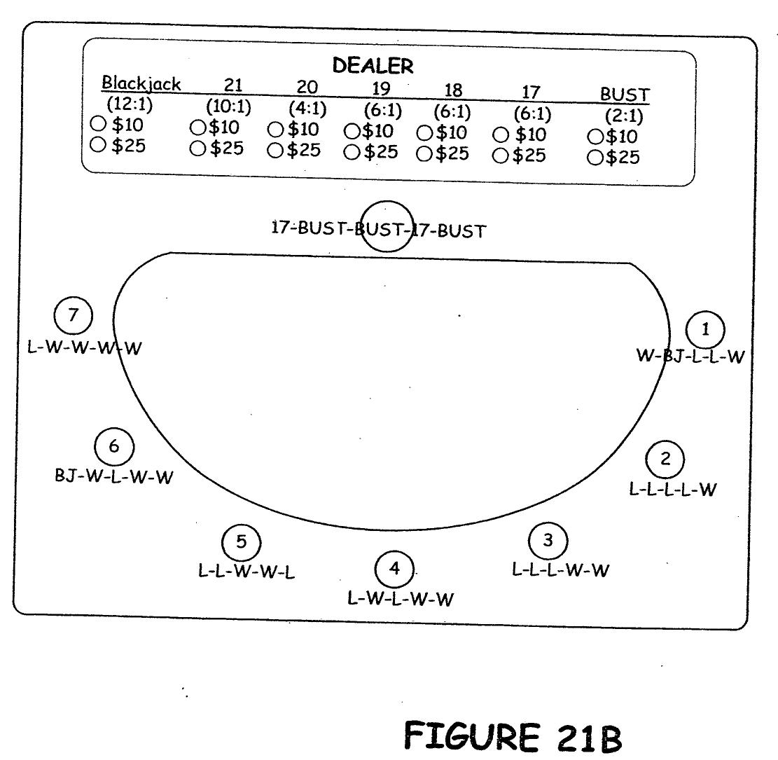

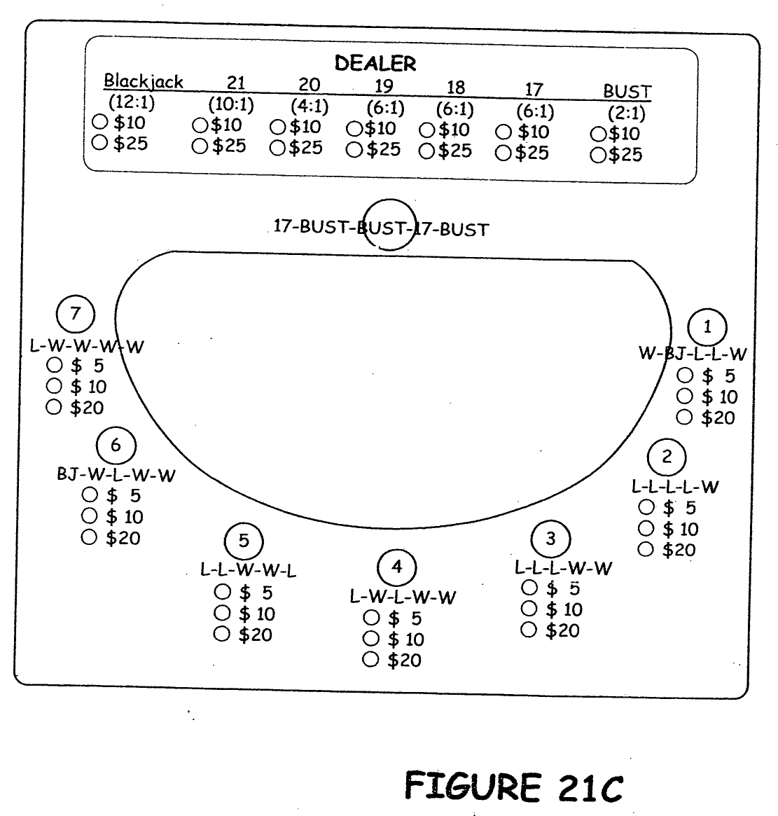

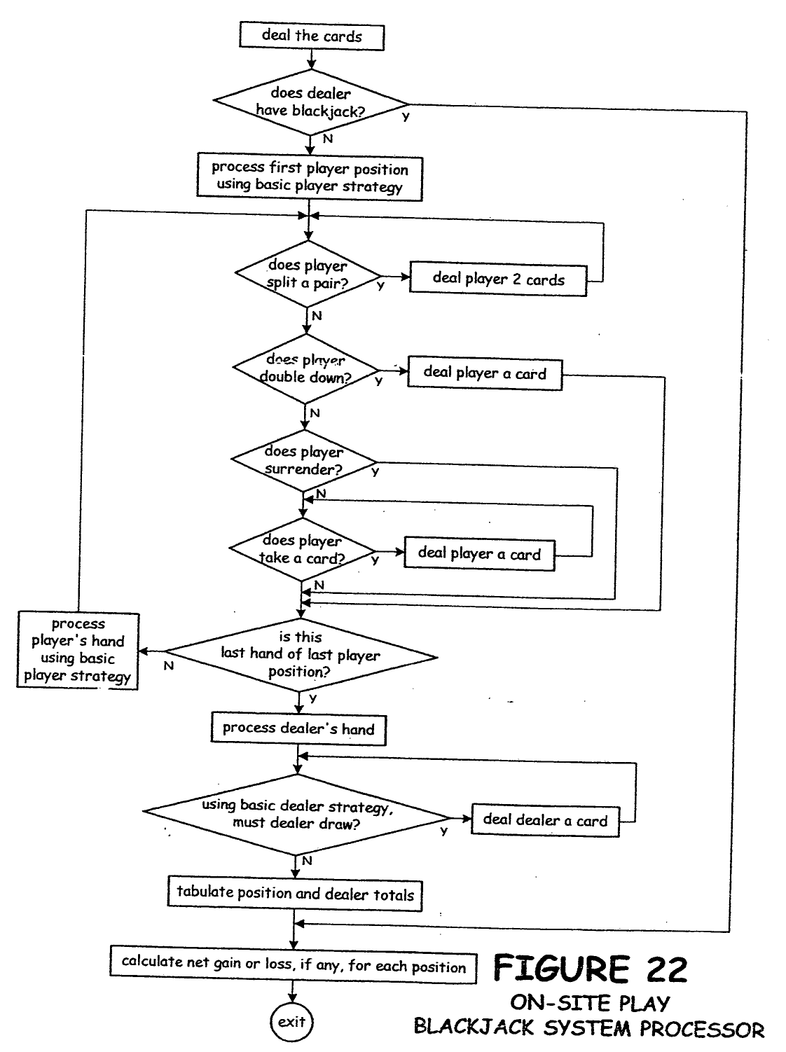

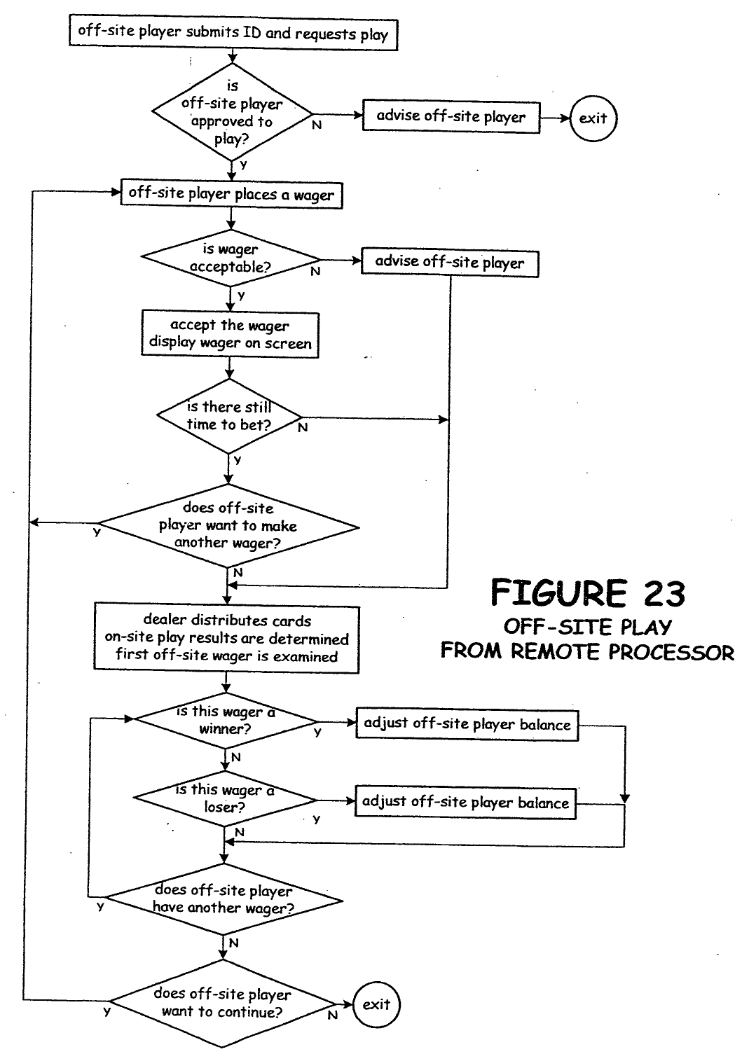

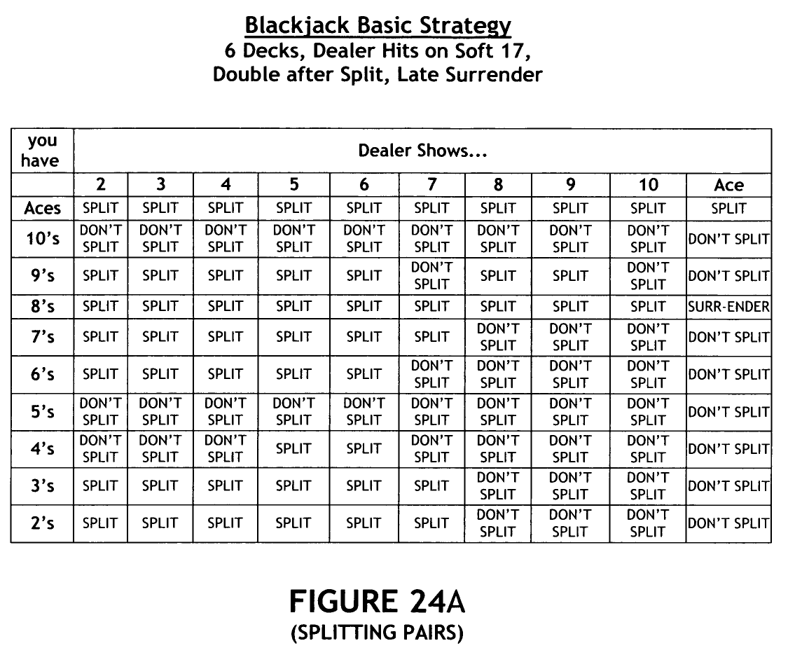

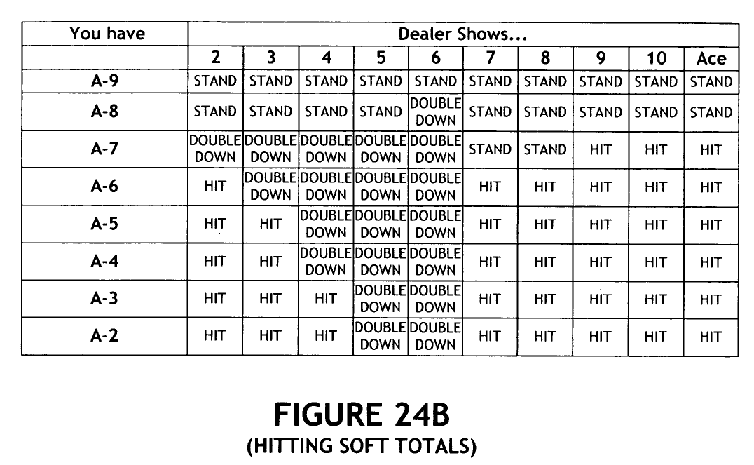

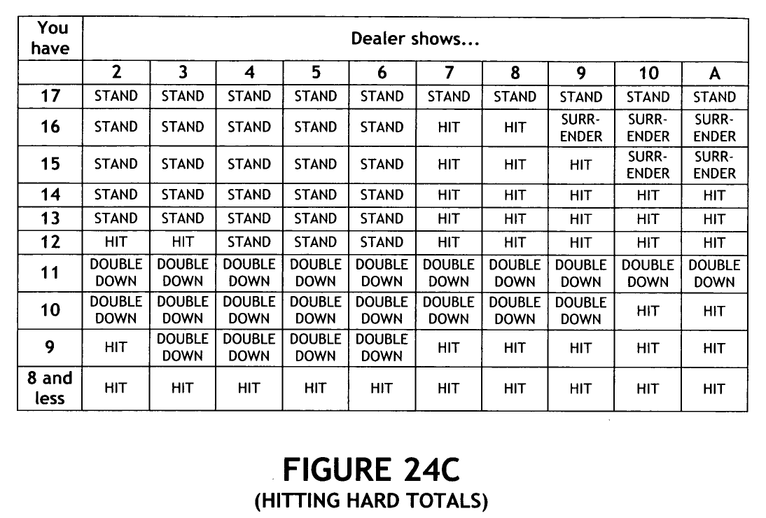

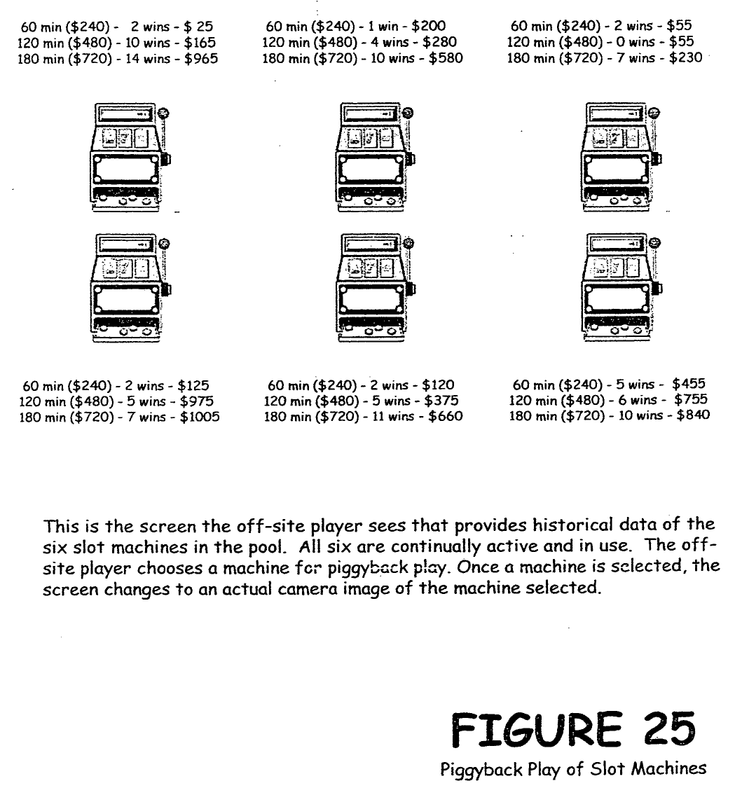

FIG. 3 discloses a preferred embodiment of the overall system, which includes a hotel/resort mainframe computer of any suitable type, such as an IBM 360 or similar computer as required for the operation of the facility and related networks (200). A similar computer and data storage system monitors the casino gaming operations (201). An SNA Gateway or similar servers interconnects the mainframe computer to the facility Intranet system; and separate servers as IBM AS400 or other units of sufficient capacity such as current 300 MHZ or better IBM compatible Pentium IIJ type servers as required for the operation of the respective Internet, Intranet, facility operations and security, financial, and gaming functions (see also FIG. 17).

The hotel mainframe, through a SNA Gateway or similar server within which all data for the operation of the facility, guest registration and credit information is stored is interconnected to the Intranet. The hotel operations Local Area Network which controls facility operations, security and registration services is interconnected to the Intranet. The registration server is interconnected to a current 300 MHZ or better IBM compatible Pentium IIJ or similar Internet gateway server through which guest or player reservations are received from remote locations and all guest or player credit information is confirmed.

The financial server is interconnected directly to the Intranet and monitors guest and player purchases, gaming wins, losses, and payouts and enables the purchase of additional credit value to a player's account to the approved limited as requested by the player.

Typically, one gaming bank server 62 is assigned to each type of activity (blackjack, slots, arcade games, etc.). There may be any number of servers, but preferably there is one server for each casino game (blackjack, craps, KENO, roulette, slots, etc.). Also, interactively engaged with the hotel/resort mainframe computer may be a guest purchases interface 150, and guest room key/security interface 110, as herein described.

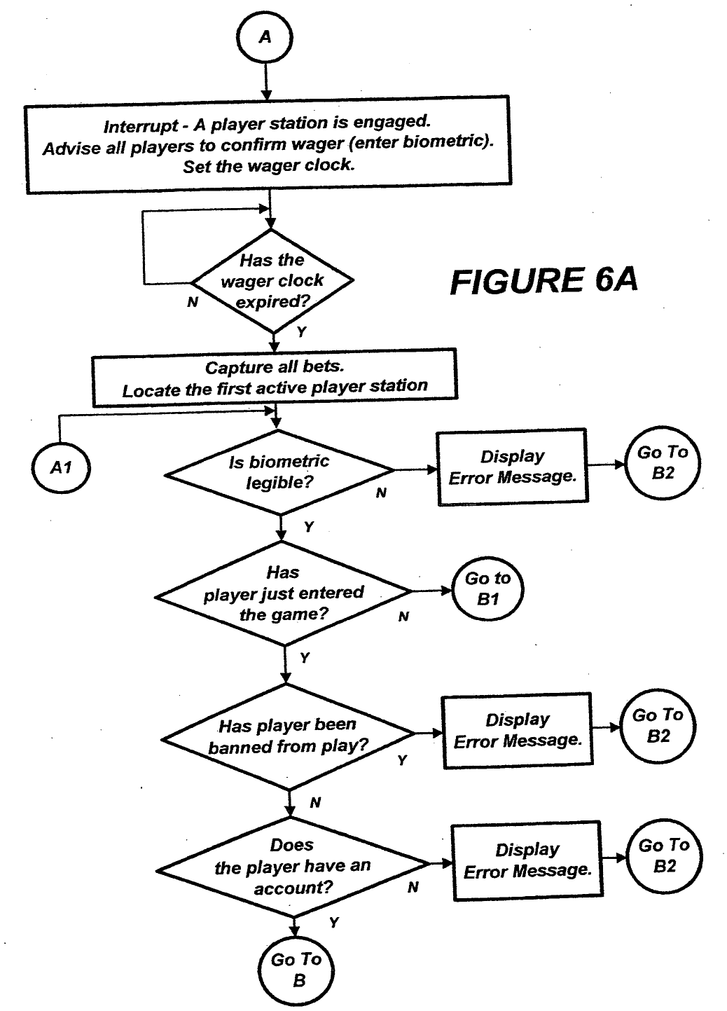

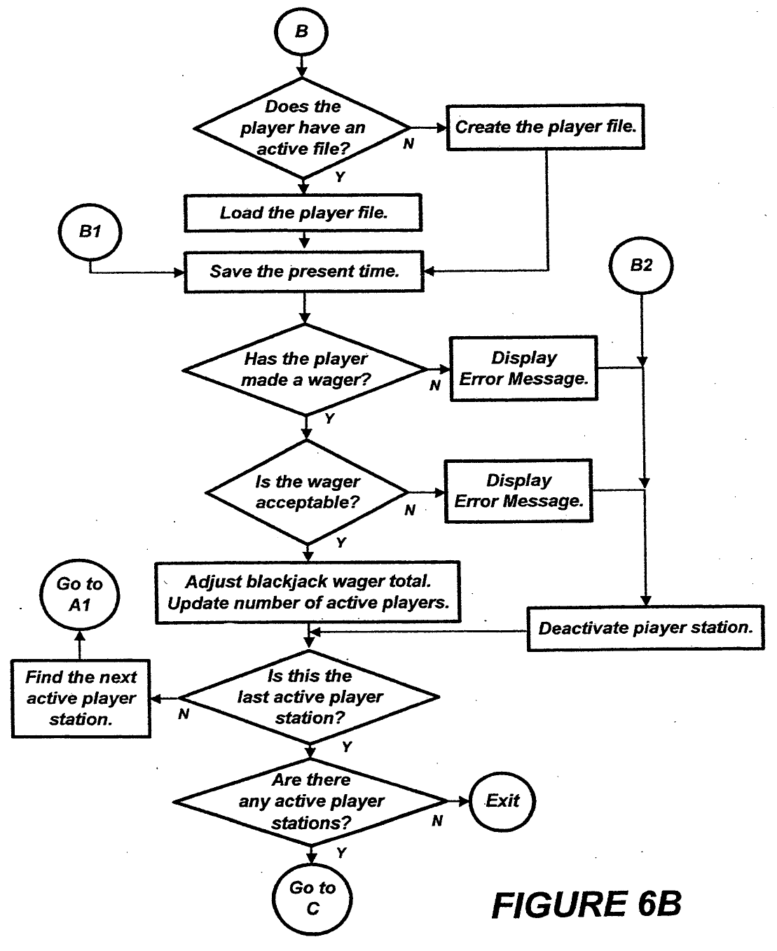

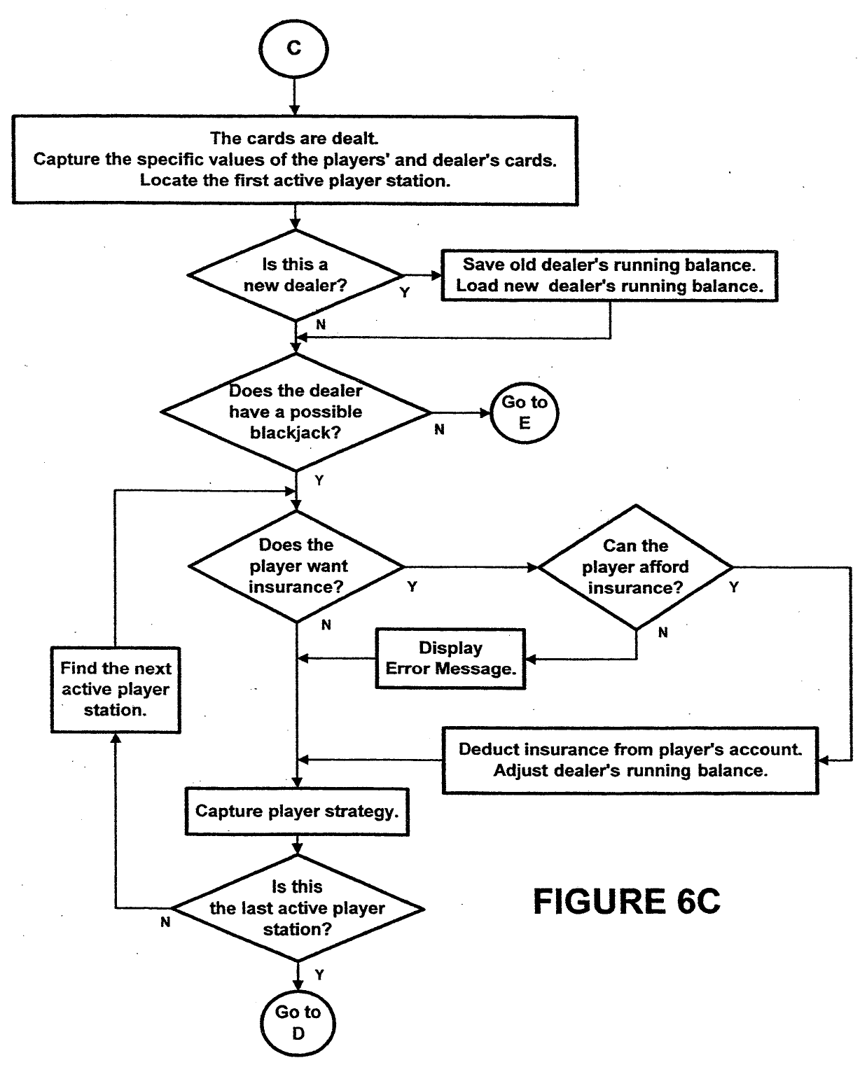

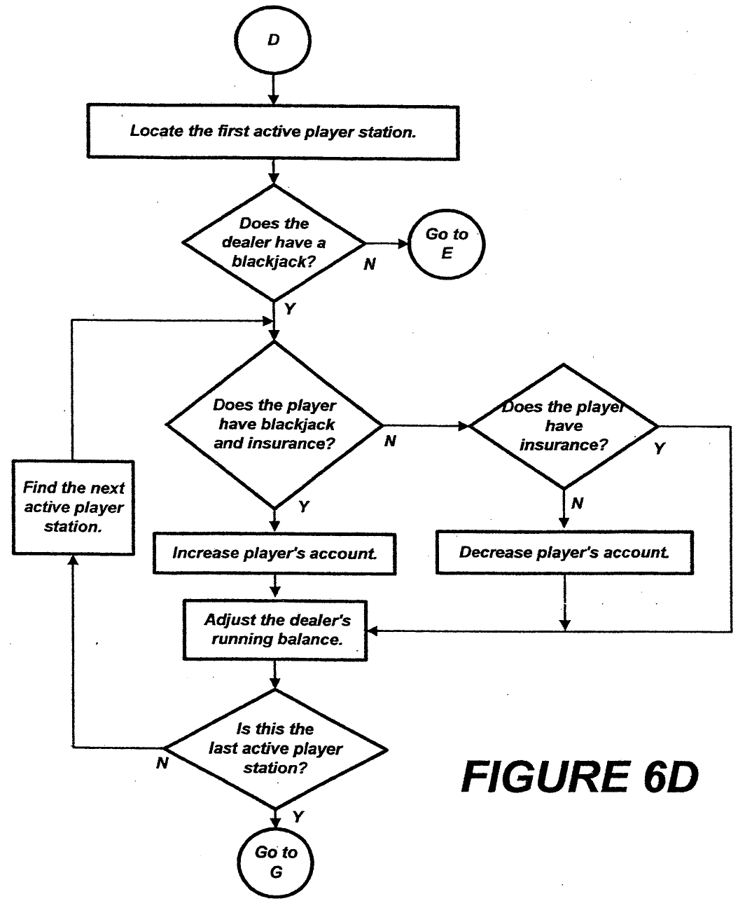

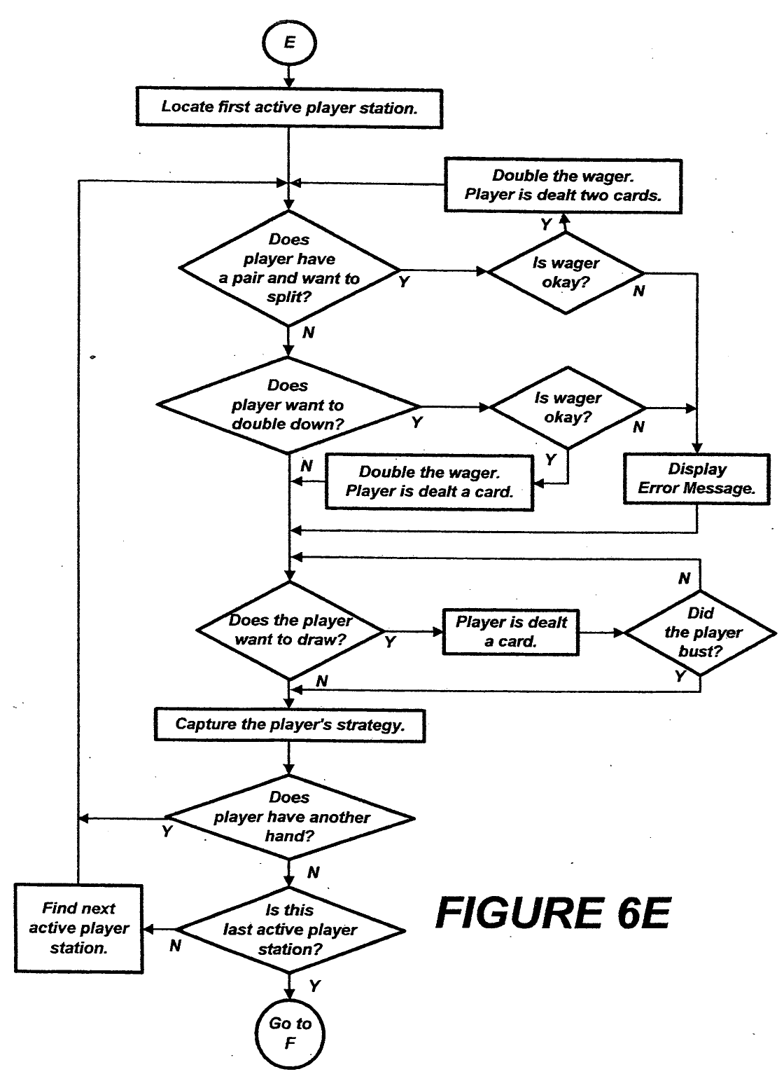

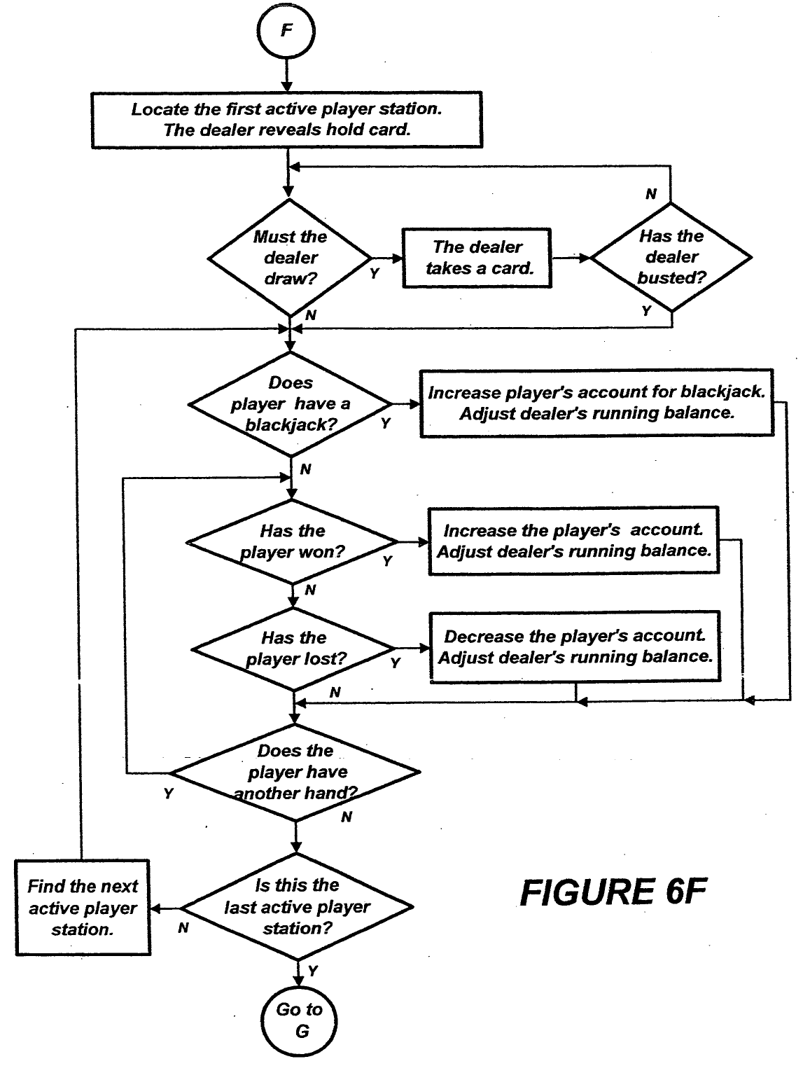

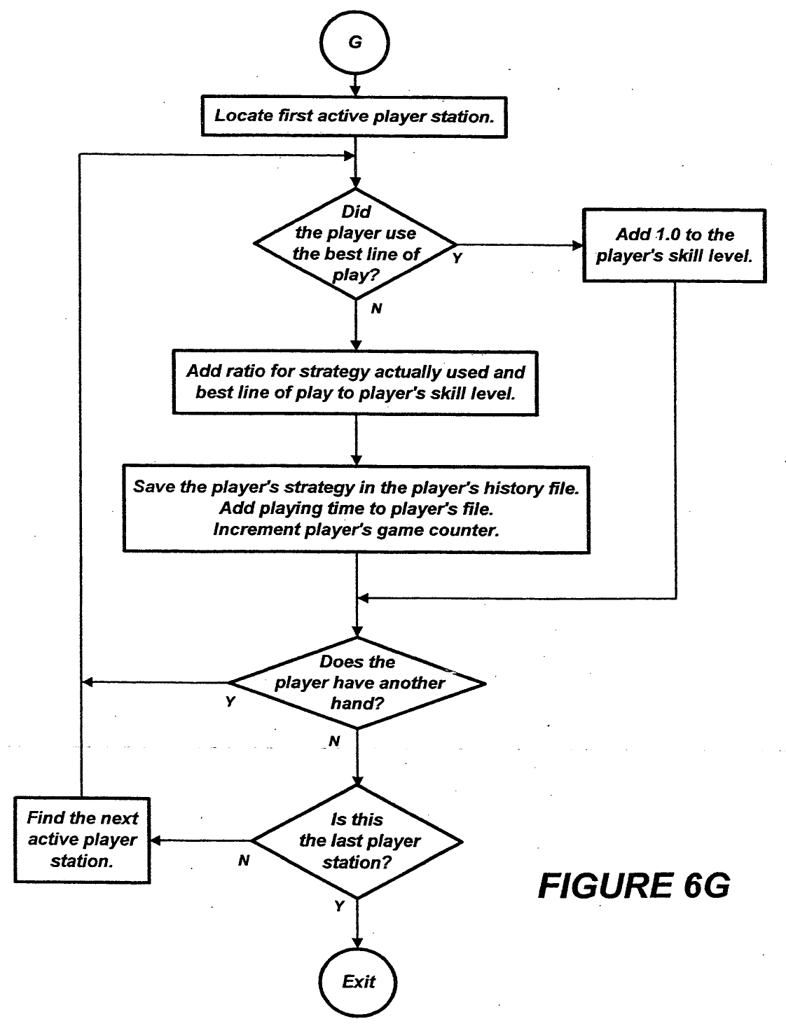

While the system is applicable to essentially any game of chance (KENO, craps, roulette, poker, solitaire, bridge, hearts, and the like), the game of blackjack will be used for purposes of illustration only. FIGS. 6A, 6B, 6C, 6D, 6E, 6F, 6G, 6H, and 6J in combination disclose a logic flowchart of a preferred embodiment of the system using a credit medium and the optical scanner 30 positioned relative to the card rack 28, but also includes a credit medium reader 50 for use with a credit medium 52 for each individual player for playing blackjack. As used herein, blackjack is considered a game of chance and skill, since the decisions that the player must make during hand require a knowledge of probability. In contrast, roulette is considered a game of pure chance, since no special knowledge is needed to play. There is nothing unique about these logic flowcharts, as one skilled in the art can design alternative logic paths.

FIGS. 6A and 6B generally disclose the clearance procedure for enabling players to enter the game by inserting their credit medium 52 and place wagers; FIGS. 6C and 6D generally disclose the logic surrounding buying insurance, and determining whether or not the dealer and the individual players have a blackjack; FIGS. 6E, 6F, and 6G generally disclose the logic involving player decisions (hitting, staying, doubling down, and splitting pairs) when neither the player nor the dealer have a blackjack; and FIGS. 6H and 6J generally being the logic involving completing the dealer's hand (if necessary), and determining winners and losers for all players not having blackjack, and adjusting the player's running balance accordingly.

Prior to play, each player inserts his personal credit medium 52 into the credit medium reader 50 associated with the player station 24. The credit medium has an initial credit balance. Each player station 24 preferably includes interactive selecting means to enable the player to enter a wager on the game outcome. After each player has selected his wager, the playing cards 26 are dealt. The computer tabulates each players' credit balance as associated with that player station 24 and that credit medium 52. During play of the game, the computer is able to track which player is active by monitoring the engagement by each player of his or her “stick” button, since each time a stick button is engaged, the next hand moves into the active position until the last hand is played, at which time, the dealer becomes the active hand, and draws if the holding is less than seventeen.

Each player in blackjack uses a credit medium 20 with which he acquires upon hotel registration, off-site registration through third parties, or on-site registration within the casino. He has access to a playing station 24 (data processing terminal) during the play at the blackjack table via the credit medium 20 and a card reader 12 disposed at the player station 24. At the beginning of each game, each player digitally selects the amount of his wager by use of an interactive keyboard on an interactive monitor. Once play begins, the credit medium 20 is locked in. At the end of each game the player is credited or debited with the amount of the wager.

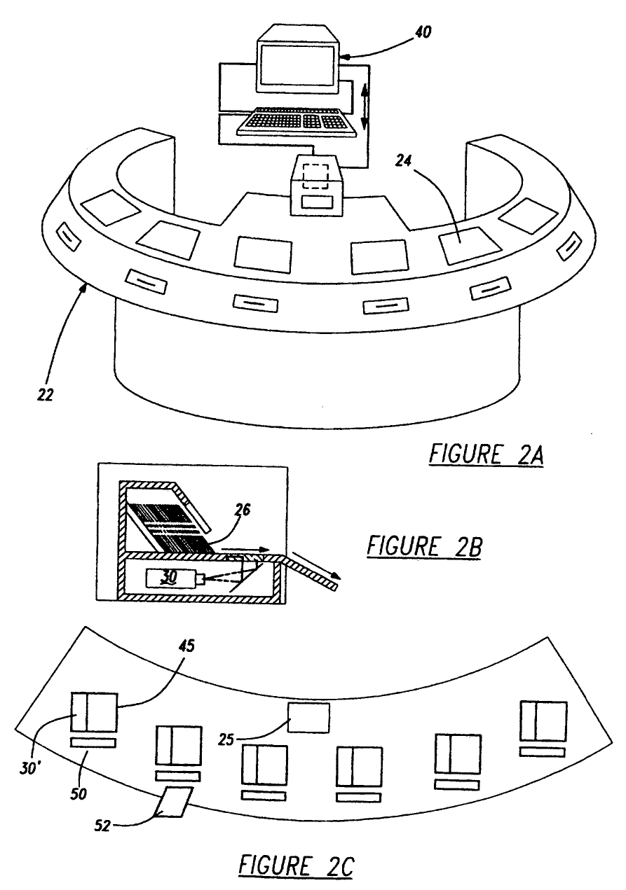

FIGS. 2A and 2C disclose the advanced gaming system for use at a blackjack table 22. The blackjack table 22 preferably includes six player stations 24, as is conventional for blackjack play, but as herein described can be readily expanded to include seven, eight or nine stations. Each station is associated with an individual player.

The playing cards 26 are randomly distributed relative to each other either by the dealer or in an automatic shuffling machine (not shown). When the cards are shuffled manually, usually four to six decks are used, and the cards are shuffled and positioned within a card rack 28, and individually dealt in sequence by the dealer. When an automatic shuffling machine is used, the playing cards 26 are gathered at the end of each hand and placed in one end of the machine, and playing cards 26 are withdrawn from the other end of the machine and distributed to the individual players and the dealer in sequence.

The sensor 30 reads the specific values of the playing cards 26 as they are dealt to the individual players and the dealer, as shown in FIG. 2B. Preferably, the sensor 30 is a high speed optical scanner that is positioned in the card rack, and is an Agfa SelectScan Plus CCD Color Scanner. Alternatively, a sensor 30′ may be positioned in the blackjack table 22 relative to each player station 24 and the dealer station 25, and the playing cards 26 are dealt face down, and read by each sensor 30′.

The specific values of the playing cards 26 as read by the optical scanner 30 and processed by a computer processor 11 for processing information relative to the specific values of the playing cards 26 read by the scanner 30. The rules of play for blackjack have already been programmed into the computer processor 11, along with the house rules. The computer 11 determines which of the individual players has won, lost, or tied, once play of the game has been completed.

Each player station 24 includes means for enabling each player to enter a wager amount relative to the blackjack game. The wager amount is confirmed prior to the play of the game, not being greater than the available credit balance. The computer processor 11 tabulates the resulting credit balance after the game has been completed. For example, if the player has a current running balance of $120, and wagers $20 and wins, the computer 11 adds the wager to the running credit balance at the end of the hand. Each player station 24 may also include means for entering decisions, a keypad 45, made by the player relative to the play of the game.

The computer 11 determines the game outcome based upon the information relative to the specific values of the gaming materials pertaining to the information as applicable to the definitive rules for play. When the gaming materials are playing cards, and the game is blackjack, there is no play of the playing cards 26, but rather the game outcome is simply determined by comparing each hand held by each individual player as against the cards dealt to the dealer. If the player splits pairs, there may be more than one hand for a player on any particular deal. Similarly, for poker there is no play of the cards, but rather the play involves wagering and determining when to stay and when to fold, so that the winner can be determined by comparing the playing cards 26 held by the individual player. When wild cards are used, the computer must be advised of which cards are wild prior to each hand. For craps, the winners and losers are determined simply by a roll of the dice, so that the dice comprise the gaming materials, and the value of the dice rolled is determined by using a sensing device, such as an optical scanner to read the bottom surface of each die to determine the specific value of the top surface, since the bottom and top surface will always add to seven (1-6, 2-5, 3-4).

The length of time that a credit medium 52 is engaged at each blackjack game can be readily determined. The time counter begins when the credit medium 52 is inserted, and the time counter stops when the credit medium 52 is withdrawn from play, when the individual player does not make a wager.

At the beginning of each hand, dealer ID is checked and a current running balance is entered into the computer if there is a change of dealers. Winnings and losses for individual players are also added to the dealer's running balance each hand, so that the casino can monitor how each dealer is doing, as a means of further checking for any irregularities during the play of the game.

To tabulate the net gain and losses of each player at each sitting, again refer to FIGS. 6A through 6J, where the player enters the game with an initial credit balance, either purchased from a credit charge station, or applied to the credit medium when the player registers at the hotel casino. At the end of each hand each player's running balance is adjusted according to the results of each game. When the player withdraws the credit medium, the initial credit balance is replaced by the current running balance.

Player usage of promotional advances may be accurately monitored by comparing the amount of the promotional advance as against the individual player's running balance which is updated at the beginning of each hand.

FIGS. 6F and 6G disclose one method to determine a skill level for an individual player during play of the blackjack game. At the end of each hand, the computer determines what the percentage of winning is had the player pursued the best line of play. The computer checks the play history for the hand to determine whether the best line of play was used. If so, the running total of the player skill level is equal to the running total of the best line of play and the player is batting 1.000. However, in those instances where the player does not use the best Line of play, the probability of winning using the strategy that the player actually employed is compared to the probability of winning using the best line of play. Whether the player won or lost using his strategy is completely discounted.

The best line of play logic is also the mechanism for determining any irregular player wagering patterns, to determine if the player is perhaps using a system or counting cards. Each time that a player diverts from the best line of play, the player strategy is saved in the player history file for later off-line analysis.

Net winnings and loses of the player at each game within the casino are determined by saving in a player history file the initial balance and the closing balance at each casino game. Player history files are maintained in the computer for all casino games, including slot machines.

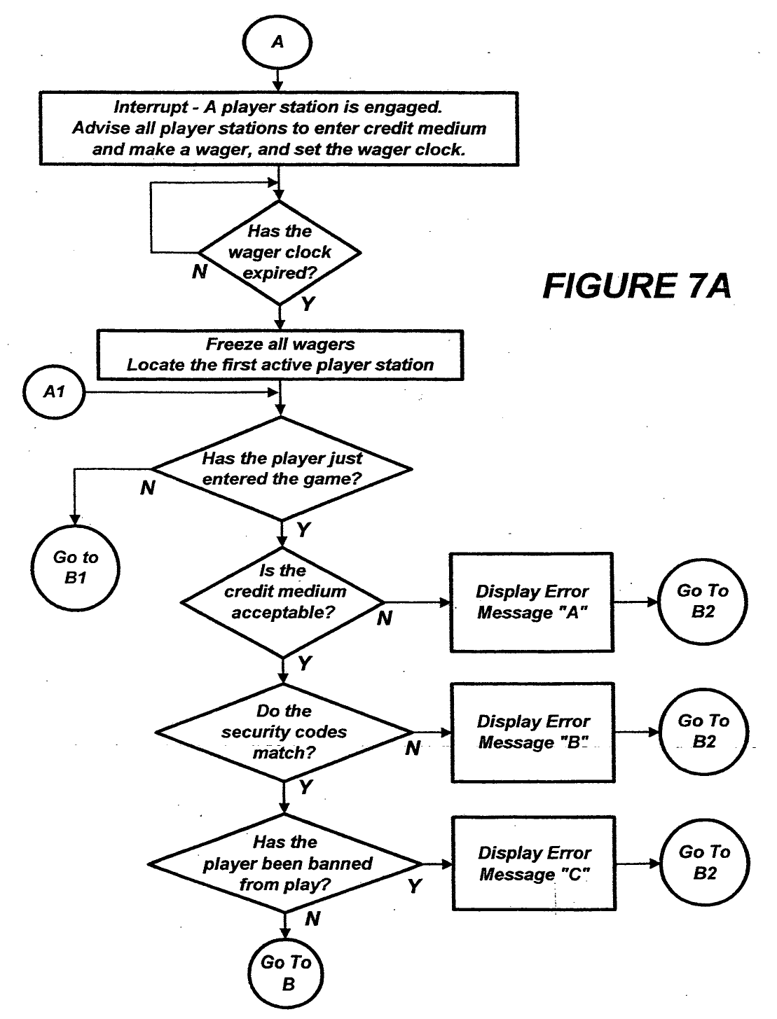

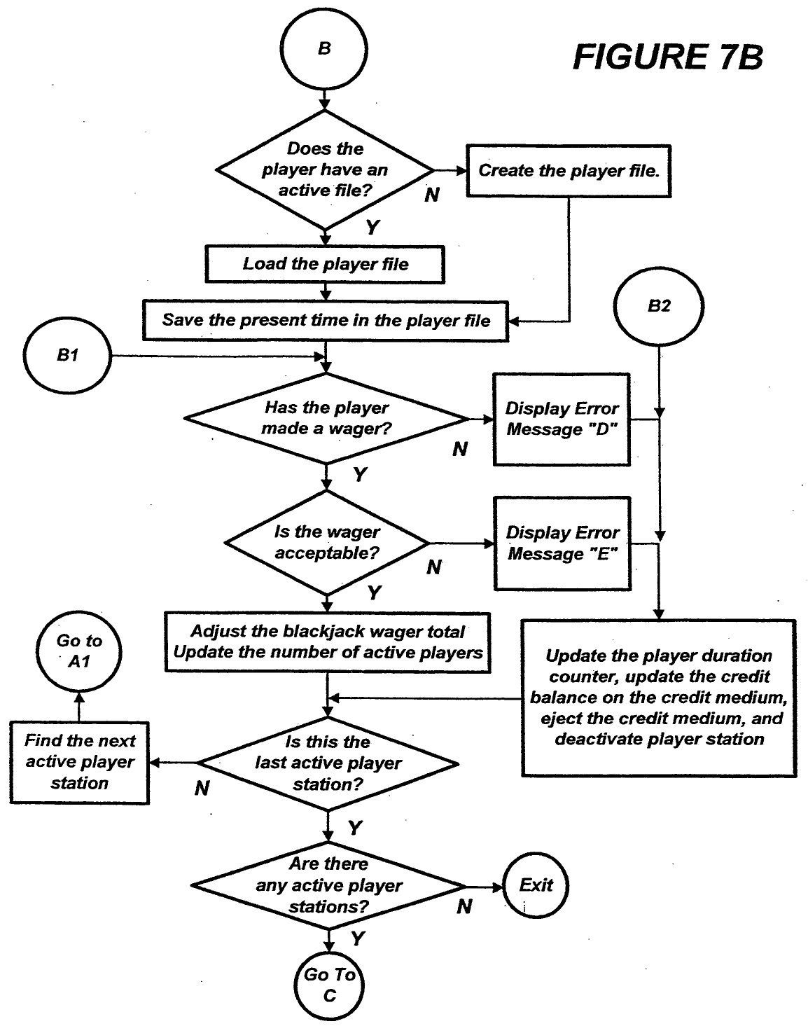

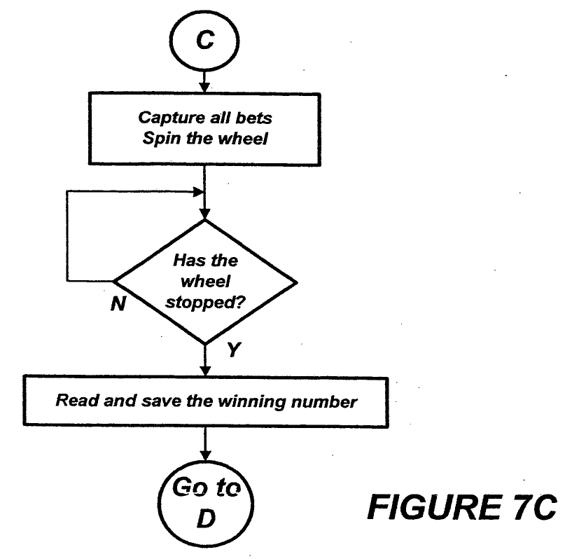

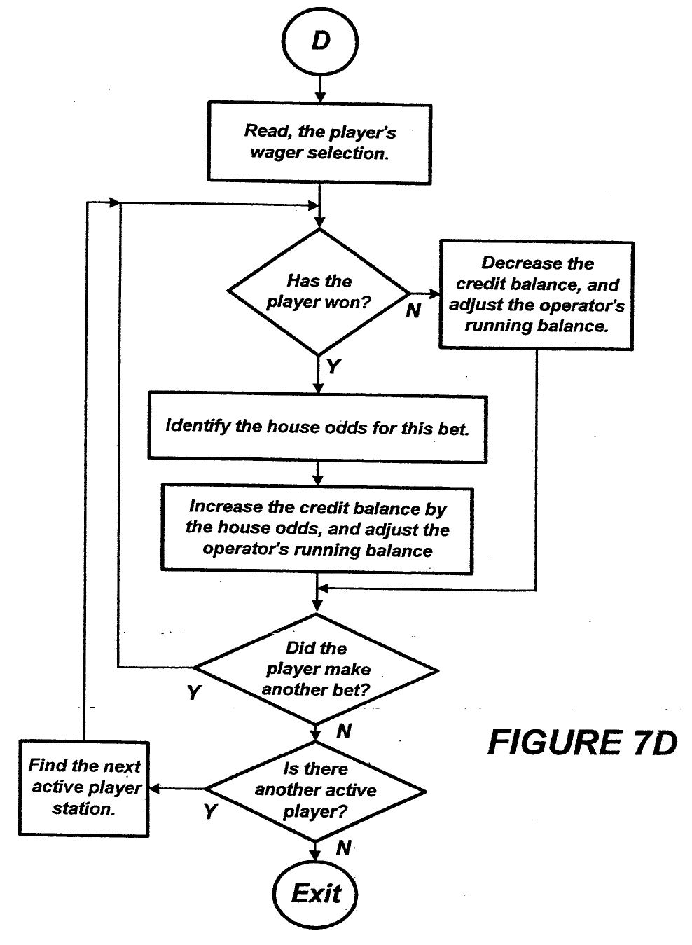

FIGS. 7A, 7B, 7C, and 7D disclose a logic flowchart for playing roulette play using the preferred embodiment of the system. The system employs both the credit medium with reader to enable a cashless and chipless system, and sensing means, to determine the game outcome. The logic path shown in FIGS. 7A and 7B is generally the clearance procedure for enabling players to enter the game by inserting their credit medium and place wagers, and FIG. 7C and 7D contains the logic for spinning the roulette wheel, examining all bets to determine winners and losers, and adjusting all credit balances accordingly. FIGS. 7A and 7B are remarkably similar to FIGS. 6A and 6B, as the clearance procedure for a card game of chance and skill (blackjack) is essentially the same as the clearance procedure for a game not involving playing cards of pure chance (roulette) as hereinafter described.

There are a number of ways to determine the outcome by sensing means in a game of roulette. A simple mechanical switch is used (normally open). When the roulette wheel stops and the ball stops and is clearly positioned relative to the winning number, the weight of the ball will close the switch, and the computer monitors each of the thirty-eight positions until the closed switch is found.

U.S. Pat. No. 5,431,309 (Kelley) discloses a card shuffling and dealing apparatus, the apparatus being designed for use in duplicate bridge, where numerous teams of players compete to achieve the highest score with identical hands of playing cards. Card shuffling machines have found increasing acceptance in casino blackjack play, where such machines minimize the amount of “downtime” between racks of cards, when the dealer must thoroughly shuffle four to six decks of playing cards. While the machine of the '309 Patent is designed for bridge, one can readily modify this design for blackjack play, whereas the machine not only thoroughly shuffles, but also then after distributes the cards. When combined with a credit medium and sensing means, such a shuffling/dealing apparatus may be used whereby this system replaces a person shuffling cards, dealing cards, separating winners from losers, making change, collecting chips from losers and paying winners.

U.S. Pat. No. 5,067,713 (Soules et al.) discloses a card shuffling apparatus using a special deck of coded playing cards, as for example a bar code, and included electro-optic reading means to identify the cards as dealt. While this device is also primarily designed for contract bridge play, one skilled in the art can readily redesign the shuffling and card reading apparatus as another alternative for shuffling and reading playing cards relative to the subject invention.

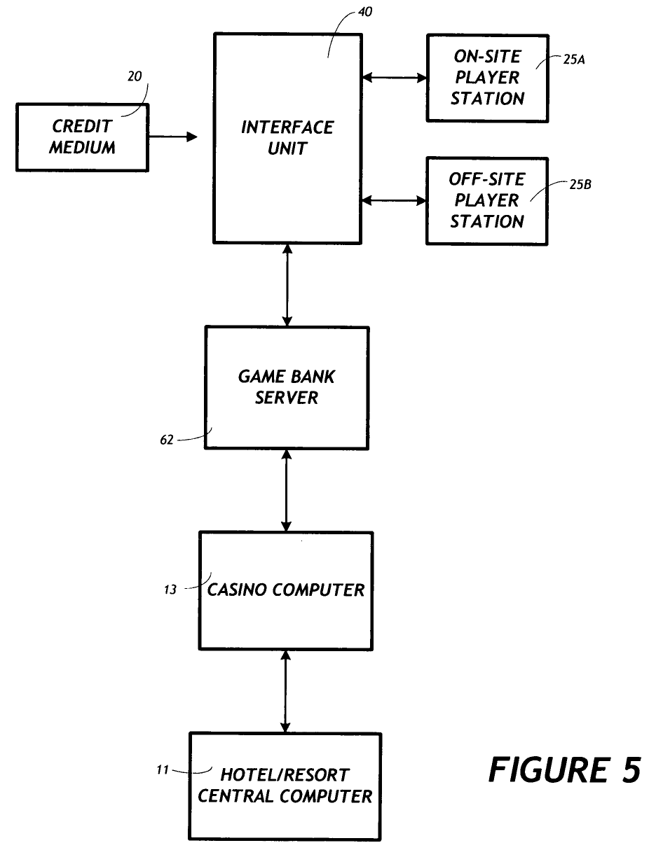

The system includes a plurality of the player stations 25 disposed relative to a gaming table, and each player station 24 is available for play by a player. Initially, the playing cards are shuffled thoroughly, either by the dealer or by an automatic shuffling machine. Each player, preferably, has a player station 24 available for play near him secured to the playing table, and a personal credit medium 20 which is engageable with the player station 24. Each player then inserts his credit medium 20 into the player station card reader 12, each player station 24 being engageable with the gaming table. Each credit medium 20 has an available credit balance stored therewithin prior to play to use the credit medium 20 (see FIG. 5).

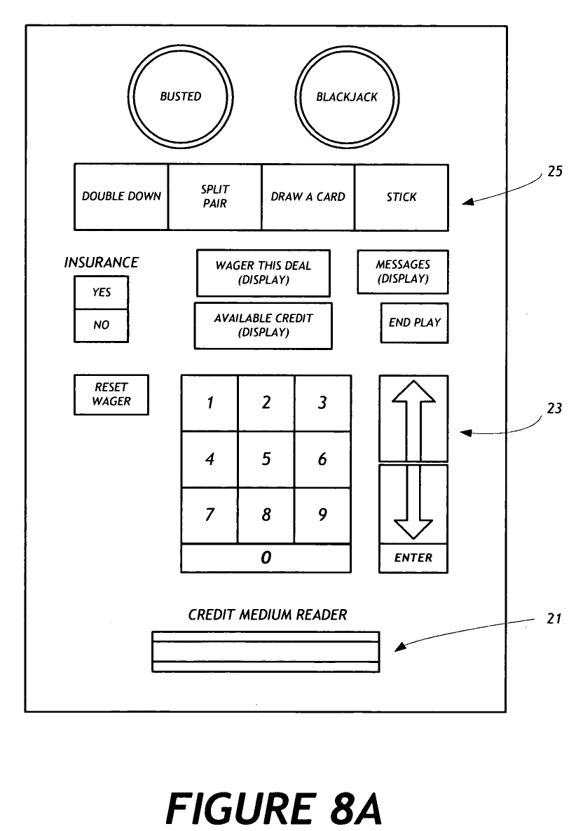

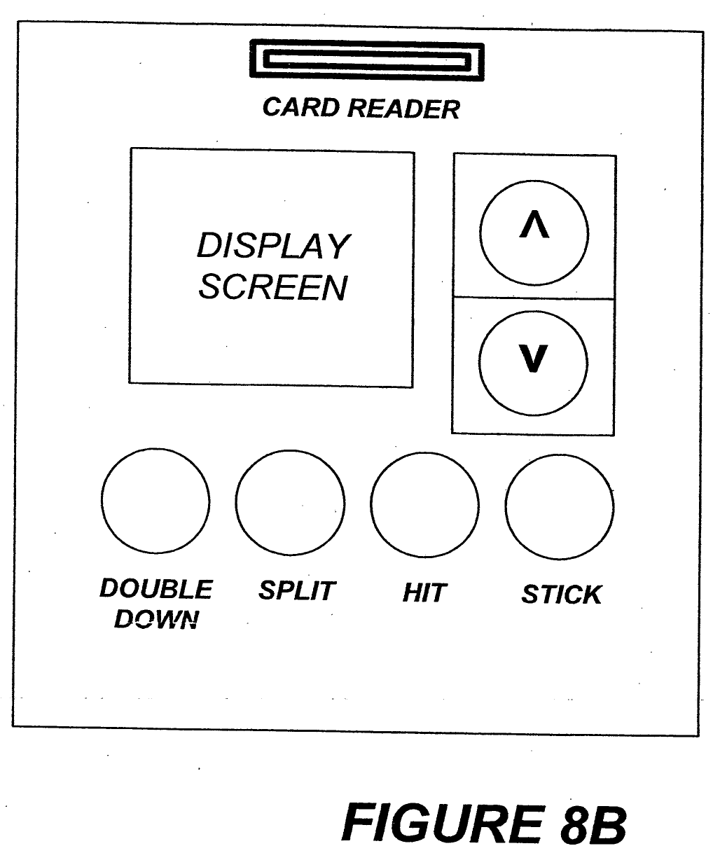

FIG. 8A discloses an exploded detail view of a first preferred embodiment of an elaborate interactive monitor and credit medium reader for playing blackjack. Each player station 24 includes interactive selecting means 14 for making a wager on the game outcome (a keyboard). The wager amount is confirmed prior to the play of the game, not being greater than the available credit balance. After each player has selected his wager the playing cards are dealt. Each credit balance is continually tabulated within a casino computer system for that player station 24 and that credit medium 20, respectively. FIG. 8B discloses an exploded detail view of a simplified interactive monitor and credit medium reader for playing blackjack.

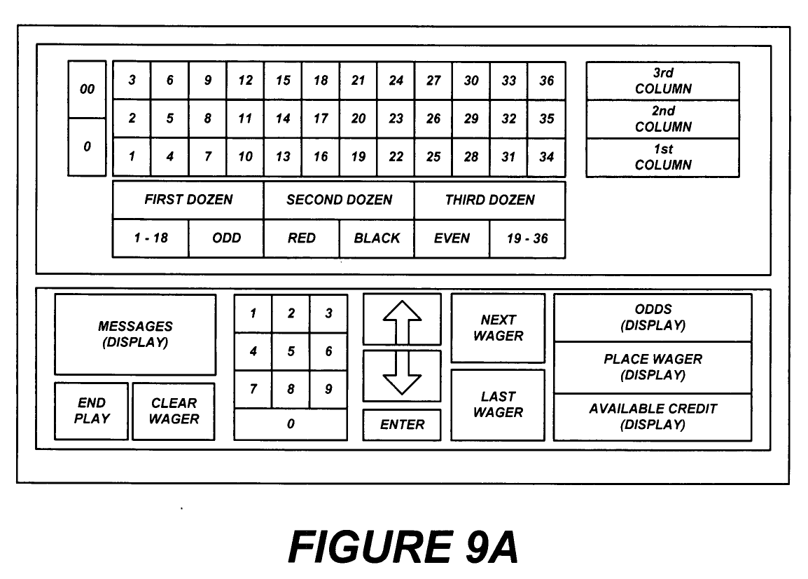

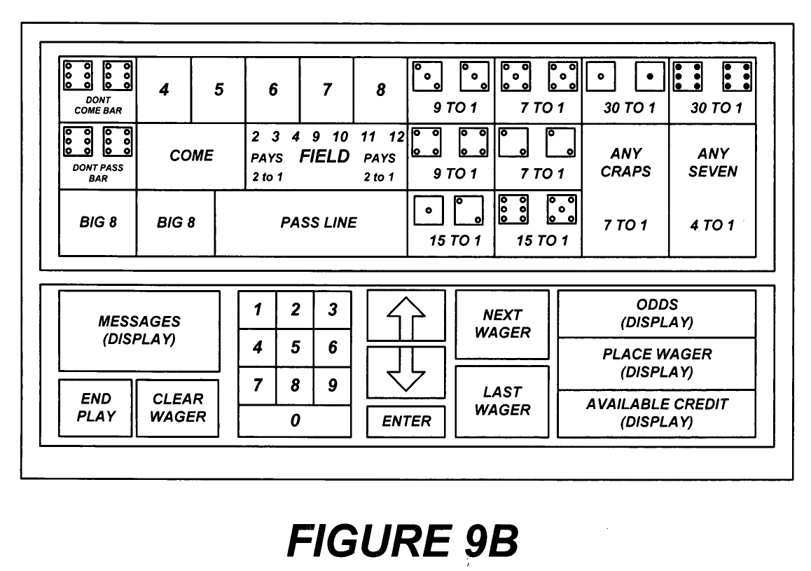

FIG. 9A is an exploded detail view of an interactive monitor and credit medium reader for playing roulette, and FIG. 9B is an exploded detail view of an interactive monitor and credit medium reader for playing craps. U.S. Pat. No. 4,339,798 discloses interactive player stations designs for use for playing craps and KENO.

Preferably, the available credit balance is not replaced on the credit medium 20 until the player decides to withdraw the credit medium 20 from the player station 24. A tabulation of a plurality of game results associated with the player at the gaming table is then inserted on the credit medium 20 replacing the previous available credit balance.

Generally in blackjack, once the game outcome has been decided the wager amount is added to or subtracted from the previous available credit balance. However, if the house takes a percentage from the top as is common in many casinos operated on Indian reservations, the calculation of the second cash value may be more complex.

It will be appreciated that for larger hotel complexes, additional casino computers 13 may be necessary to accommodate more players. The hotel central computer system 11 will also be interactively engaged to room service, security, reservations, registration, checkout, or additional servers similar to the casino computer system 13 may be used for each function.

The hotel central computer system 11 is also interactively engaged with phones, restaurants, and shops, which can also be direct connections or through IBM PC's. The casino computer system 13 is interactively engaged with cashier stations 145 each including a cashier terminal, which enable a player to increase or decrease the value of the available credit balance on the credit medium 20.

Activities at tables, slot machines, arcade games, in addition to sports betting and race betting which require repeated responses are preferably routed through the casino computer system 13 (see for example U.S. Pat. No. 5,371,345). In the preferred embodiment as shown in FIGS. 1A and 3, the information from the individual units (cashier stations 145, gaming bank server 62, and maintenance management security unit 140, is transmitted to the casino computer 13). The casino computer 13 and the hotel computer 11 thereafter exchange information which is transmitted back to the individual units through the casino computer 13. In another embodiment (not shown) the hotel computer 11 receives the information through the casino computer 13, but then feeds back information directly to the individual units.

Each guest is issued a unique house card key, which not only is useful for obtaining entry into the hotel guest room, but for eating, and other entertainment activities on the hotel premises. Each key has a PIN and individual available credit balance. Some guests may prefer to have no available credit balance, in which case the house card key is only used to gain access into the room. However, the guest may later decide to purchase credit for use on the hotel complex, which may be accomplished through card recharging machines located throughout the hotel.

While a personal identification number (PIN) can be used as a personal identifier, this method is not particularly secure, since another may learn the PIN while eavesdropping during PIN entry.

A biometric identifier is a stable physical property which is easily measured and characterized for subsequent use. The credit medium will include the biometric identifier, which is preferably a thumb print, that is inserted onto the card during acquisition. Subsequently, when the card is inserted into the card reader for play, the player will place a thumb print onto the interactive monitor. The credit medium is validated by comparing the encrypted thumb print to the thumb print of the user of the credit medium. Such an identification system can be used in other sites on the premises of the complex whenever the credit medium is used.

Another option is to enable to use a thumb print or other biometric identifier as the credit medium. The player simply provides the hotel with a thumb print upon registration, whereby a room is assigned. To enter the room, the guest provides a thumb print onto a screen, which is then matched by the computer with the thumb print of the guest who has access to the room. To play in the casino, the player submits a thumb print onto the keypad and the system matches the thumb print with the particular guest and the available credit balance. To add value to the guest account, value is withdrawn from a credit card, or debit card, or cash or check, and such value is added to the guest's available credit balance. To access the available credit balance in areas other than the casino (restaurants, lounges, boutiques, etc.), the guest supplies the vendor with a thumb print which is matched to the guest and guest account in the main computer and the available credit balance is adjusted accordingly.

Other forms of biometric identifiers include fingerprints, handwritten signatures, finger length, hand geometry, retina or iris scan, facial thermography, facial imaging, and wrist vein patterns. As these technologies become further developed, many will be preferably to thumb prints, since patrons are sometimes hesitant to thumb prints or other hand identifiers since it suggests law enforcement involvement. A handpunch that is commercially available from Pitrone & Associates of Hatboro, Pa. is another identifier that may be used. The system provides positive identification when the user inserts his hand into the confirmation device. Another system involves a face print and is currently being used by governmental facilities to control access. The system works like a fingerprint and takes an infrared picture of a person's face including the blood vessels. The various temperatures of the facial region have differing temperatures as where the blood vessels are. Authentication begins by matching general facial features and then proceeds to the finer data points.

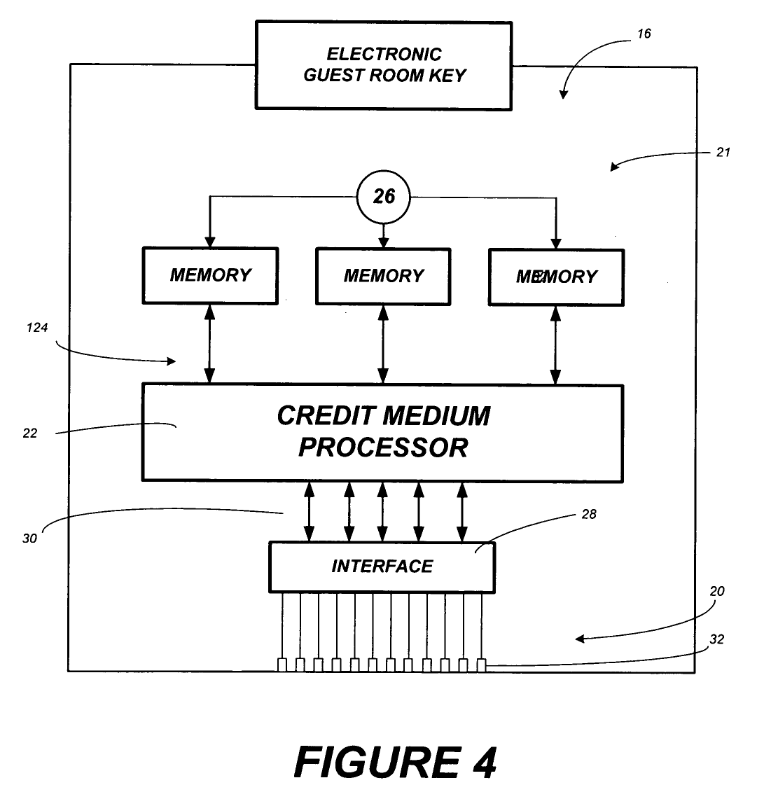

FIG. 4 discloses the preferred embodiment of the data containing apparatus 21, having a credit medium 20 disposed at one end, and an electronic guest room key 16 disposed at the opposing end thereof. The credit medium 20 includes a microprocessor 22 interactively engaged by data lines 24 to a number of non-volatile random access semiconductor memories 26 (see for example U.S. Pat. No. 5,179,517). Microprocessor 22 is interactively engaged with an interface circuit 28 by a group of data and control lines 30. Communications to external devices is facilitated by a group of contacts 32 interactively engaged with the interface circuit 28. Preferably, these contacts 32 conform to an industry standard, such as ISO/DIS 78161/1 and 78161/2, and include contacts for chip select signals, clock input signals, a data input signal, a data output signal, a power supply input, a status input signal, a ground line, and a memory type signal.

The circuit elements 22, 26, and 28 can in effect function as a small computer system by, for example, accepting data and control signals from external devices connected to contacts 32, using the microprocessor 22 to process the data, reading and writing data into memory 26, and transmitting data and control signals via the interface circuit 28 to the external devices.

The circuit elements 22, 26, and 28 are mounted on a bottom sheet and covered or sealed within the credit medium 20 by a cover sheet, with a portion abutting the contacts 32 left open to provide access to the contacts 32.

Although the embodiment of the credit medium 20 has been described in terms of an IC card, other configurations or structures that provide a data memory along with a data processing capability can also be used (see also U.S. Pat. Nos. 4,725,924; 4,727,726; 4,733,061; and 4,764,666).

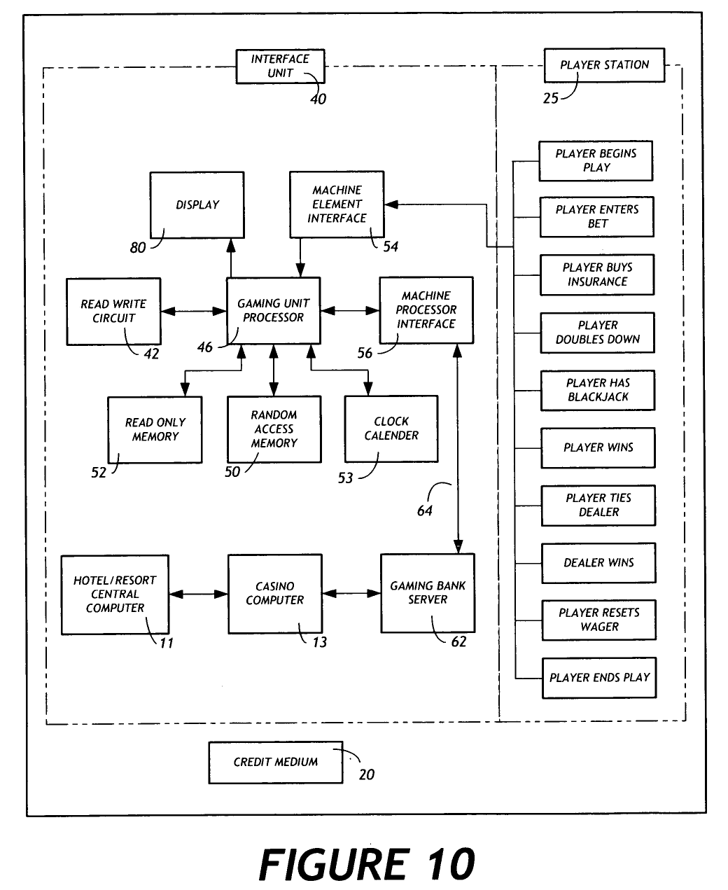

Use of the credit medium 20 with a player station 24 may be facilitated by an interface unit 40 secured within the housing of the player station 24. The interface unit 40 is secured to the player station 24. A read/write unit 42 receives the credit medium 20 via a slot configured in the housing of the player station 24. The read/write unit 42 includes contacts corresponding to the contacts of the credit medium 20 along with conventional signal interface and buffering circuitry (see FIG. 10). Also, included in the interface unit 40 is a gaming unit processor 46 interactively engaged with the read/write unit 42 by data and control lines represented by line 48 and a random access memory 50 along with a read only memory 52 that contain the control instructions for the gaming unit processor 46. A clock-calendar circuit 53 is also interactively engaged with the gaming unit processor 46.

After the credit medium 20 is initiated, it is ready for use with the player stations 25. The player will insert the credit medium 20 into slot 12 of the read, write circuit 42 of the interface unit 40 as shown in FIG. 10. The read/write circuit 42 is under the control of the processor 46 and causes the circuit to transmit to the credit medium processor 22 on the credit medium 20 the appropriate instructions so that the identifying date is transmitted to the processor 46. The credit medium processor 22 can encrypt using one of the NBS encryption standards the data being transmitted to the gaming unit processor 46, and the gaming unit processor 46 can in turn use a matching algorithm to encrypt the data.

Once the credit medium 20 has established communication with the interface unit 40 and been identified as a player type card, the interface unit 40 will make available to the player station 24 the available credit balance information. The information is transmitted via the machine interface 56 through a data bus 64 to the gaming bank server 62. To enable comprehensive player tracking information, as the player operates the player station 24, data representing game play is transmitted to the interface unit to memory in the credit medium 20.

Since a preferred embodiment of the invention is described within the context of a microprocessor-based blackjack table, the interface unit 40 also includes a machine element interface circuit 56 interactively engaged with the gaming unit processor 46 by data and control lines. The player station 24 is interactively engaged with the interface unit 40 to a gaming bank server microprocessor 62. The gaming bank server microprocessor 62 monitors the play of the game. The player station 24 also has a number of discrete signal sources that represent the status of the game for an individual player. Representing examples of status signals of the gaming table are player enters play, player enters bet, player buys insurance, player doubles down, player has blackjack, player wins, player ties dealer, dealer wins, player resets wager, and player ends play. The status signal sources are interactively engaged with the machine element interface 54 by a series of lines. The machine element interface 54 is interactively engaged with the gaming unit processor 46.

The interface unit 40 also includes a display 80 which is interactively engaged with the gaming unit processor 46 by a conventional set of data address and control lines represented by line 80.

Also, as shown in FIG. 10, the data transfer system utilizes the gaming unit processor system 62 to perform general casino accounting functions which are transferred to the gaming bank server. The interface circuit 28 (see FIG. 4) includes contacts for the transfer of data through a read/write circuit 42. In instances where a large number of like gaming tables or machines are being administered by a gaming bank server, the gaming bank server or servers being interactively engaged with the individual gaming processors through respective machine processor interfaces 56 and accompanying data bus 64. Preferably, centralized control of the gaming data and transactions is maintained. Accordingly, a data communication network, such as a local area network, is used to interactively engage the gaming processors to the gaming bank servers. A second local area network preferably interactively engages the gaming bank servers with the casino computer 13.

The credit medium 20 may be similar to a card bought at a public library for paying for copies or computer listings. The credit medium 20 such as a debit card, or a house card contains an available credit balance for play by the player throughout the casino. The credit medium may also be a smart card, whereby the available credit balance and other information relative to the card-owner is stored on the card. Duplicate information may also be stored within the computer system.

Preferably, all stations that accept the credit mediums 20 are interactively engaged with the casino computer system 13. The casino computer system 13 has a file for all active players which includes personal identification numbers (PIN's), room numbers (if appropriate) and the available credit balance for each such player. For security reasons, it is preferred that the PIN is not stored on the card, but rather only in the main computer. When the card is inserted for play, the computer performs a number of security checks. The player enters a PIN which is verified against the PIN in the computer. Then the system confirms that the available credit balance on the card matches the available credit balance associated with the PIN and player stored in the computer. Finally, if the card is also a room key 16, it confirms that the room number is the same as the room number for that particular player.

Each player station 24 may also include means 16 for entering decisions made by the first player relative to the play of the game (draw, stick, double-down, or split pairs). This information may be entered by way of a digital keyboard, a touch-sensitive interactive television monitor, an interactive voice recognition system, or a mouse in combination with a computer-type monitor.

The credit medium 20, preferably, includes personal identification number, enabling player identification prior to use of the credit medium 20. Other personal identification means may include a fingerprint, a password, or a security code disposed within the credit medium 20, enabling player identification prior to enabling use of the credit medium 20.

Preferably, the credit medium 20 is the hotel guest key for the player, who is also a guest at the hotel associated with the casino. The available credit balance can be selected by the guest when he registers at the hotel, and paid for at the time of registration by check, credit card, debit card, or cash. In addition to using the credit medium 20 at the casino, the credit medium 20 may also be used in slot machines and gaming tables situated throughout the hotel, as well as restaurants, newsstands, gift shops, boutiques, and the like associated with the hotel.

The system is for use in casinos having large numbers of gaming tables. Some of the tables may be conventional, using chips and cash to accommodate players who prefer to gamble in a conventional manner. Some other tables will be like those described in the present invention, where the playing stations are compatible with house cards. The credit medium 20 is a hotel key for use of players staying in the hotel, and either debit cards or house cards for players not staying in the hotel. Still other gaming tables will enable players to use portable stations that are compatible with the table. The stations may either have electrical connections with the gaming tables or they may be wireless.

It is appreciated that player monitoring by the casino computer system 13 can only be accomplished at tables and machines where the credit medium 20 is used by the player. Accordingly, the hotel and the casino will encourage use of the credit medium 20 by providing the player with promotional and play incentives to encourage players to try the system. It is believed that with the improved and faster play that the players will soon be comfortable with the system, and reverting to conventional play will be dull.

The player station 24 may be built into and integral with the gaming table, or the station may be portable and compatible with the gaming table. A portable station may even be wireless. The portable gaming stations will have all of the features of the gaming station that is integral with the gaming table.

The portable player station may also be initially engaged with a mechanical key, or the like, which is charged when the patron registers at the front desk with an available credit value, or the portable player stations can be borrowed and charged by employees of the casino, either for adding cash value to the station or for players who are not staying in the hotel associated with the casino.

Once the player has finished playing in the casino, he simply returns his credit medium 20 to a cashier or a desk clerk at checkout, wherein the available credit balance on the credit medium 20 is transferred directly to the players debit card, or to a personal checking or savings account.

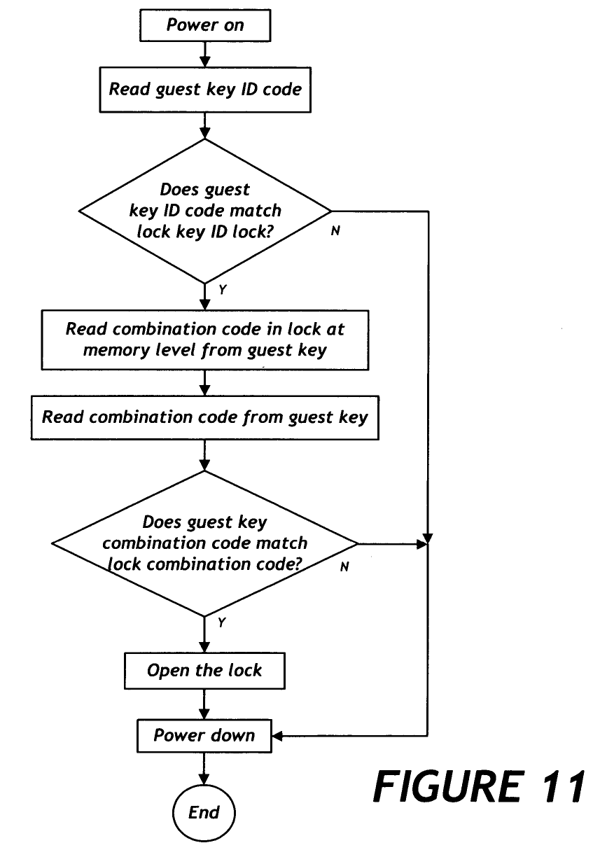

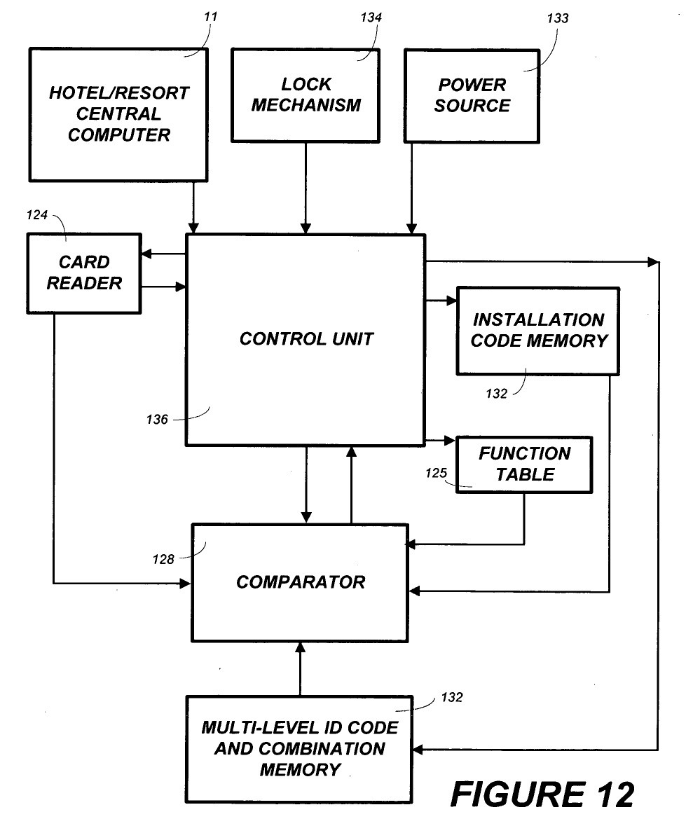

One embodiment of the invention involves a guest room key 16 on the same card as the credit medium 20 (see for example U.S. Pat. No. 4,677,284). FIG. 11 discloses a preferred embodiment of a schematic flowchart disclosing the program logic for enabling the guest to use the guest room key 16 of the data containing apparatus 21 to gain access to his room. FIG. 12 discloses a preferred embodiment of a functional block diagram of a guest room key 16, the operating codes of which are disposed on the data containing apparatus 21 opposite the credit medium 20.

An electronic key card has a set of data encoded on one end thereof. The lock includes a multi-level memory 122 with each level identified by an identification code. A combination code is stored at each memory level in memory. The set of data encoded on the key card comprises an identification code and a combination code. The data encoded on the guest room key 16 is read into the lock by a card reader 124. The lock 120 may perform a number of predefined functions, such as opening the lock, changing the codes in multi-memory, or erasing the codes in multi-memory. The predefined functions are stored in a function table 126 with each predefined function identified by a function code, which are also stored in the function table 126.

The lock includes a comparator 128 for comparing the inputs to each other. Power to the lock 120 is provided by a power source. The lock 120 includes an installation code memory 132 for storing an installation code. The installation code must be matched before a function may be performed. The control unit 136 controls the activity of all the electronic components of the lock 120 as described above, and is interactively engaged directly with the hotel/resort central computer 11.

The security system operation begins when the guest inserts the user key into the lock card-reader and the card reader reads the identification code. The control unit signals compare the key identification code to the code in the lock memory. If the identification codes do not match, the lock removes the power from the lock, except that necessary to maintain the data in memory. This sequence of events is termed “power down”. After the lock performs the “power down” sequence, the operation of the security system is completed.

If the identification code on the end of the user key does match the lock identification code, control unit 27 signals a multi-level memory 36 to transmit the combination code at the memory level identified by the combination code from the key to the comparator. Control unit 27 further signals card reader 18 to transmit this combination code to the comparator. The combination codes from the key and the lock are compared. If the two combination codes match, control unit 25 signals lock mechanism 33 to open. After signaling the lock mechanism, the control unit performs the power down sequence, completing the operation of the system.

In order to maintain the integrity of the system, the hotel/resort central computer interface is separate from the casino functions, so as to prevent hotel staff from gaining access to tracking casino gambling data for hotel guests on a routine basis. The only information that the front desk needs to know about casino guest data is available credit balance for the guest for purposes of checkout. In the event that the guest questions casino credit balance information during checkout, the guest can request such information directly from the system during checkout, perhaps by using his PIN, and the itemized statement can be reviewed with management on duty.

Another application for the system of the present invention includes cruise liners. The system is also useful in any hotel to improve security involving on-site charging to a room. In addition, the system may be used in any other controlled environment involving continual activity, or extraordinary expenses.

The off-site playing system of the present invention includes a live gaming site, a gaming processor, an off-site terminal, and a credit medium for use at the off-site terminal.

The gaming site includes a plurality of playing tables disposed within the casino. For blackjack, each table comprises a dealer and a plurality of players. For craps, each table includes a plurality of playing positions about the craps table, a casino game manager, and a roller.

The gaming processor has direct access to information from the gaming site relative to the specific values of gaming materials (cards, dice, roulette ball and wheel, etc.) relative to a gaming unit and historical information relative to the outcome and values of the gaming materials per each gaming unit;

The credit medium is assigned to the patron from the resort, hotel, or casino complex and includes a playing value that can be accessed by the processor relative to the off-site play. The key-card uses a biometric identifier, such as a fingerprint, which insures that the player making the wager is the player to whom the card is issued. The biometric identifier prevents any unauthorized use and enables the cardholder to use the card anywhere within the complex. Hence, the key card is of no value to third parties and is completely secure from theft or being lost.

The player terminal is located remote from the gaming site. The terminal has access to information in the gaming processor relative to historical and statistical information regarding previous gaming units. The remote playing terminal includes a card reader whereby playing value can be accessed relative to the credit medium. The playing terminal enables additional wagers to be placed from an off-site location regarding individual playing positions or players at the on-site game.

The off-site playing system of the present invention is simple to operate for player access, while enabling advanced statistical and historical data and analysis systems for the more sophisticated computer user. The off-site terminal will enable the off-site player to participate in a way that is no more complex than play for the on-site player. The off-site player will initiate play by selecting an off-site terminal. The off-site player then inserts his credit medium into a card reader that is integral with the off-site terminal. While the use of an interactive monitor with a touch sensitive screen is used by the off-site player, player decisions can also be entered through speech which is a more natural way of communicating. Speech recognition systems are currently available to communicate information, and can serve as a biometric identifier through voice patterns.

Once confirmation for off-site play is made, the off-site player can selects a game, such blackjack (single deck, 2-deck, 4-deck, 6-deck), craps, roulette, KENO, slots. Once a game is selected, the off-site player is presented with a series of table selection criteria. For example, in blackjack, the selections include:
Identify the coldest dealer.
Identify the hottest dealer.
Identify the coldest table.
Identify the hottest table.
Identify the dealer with the most cold streaks.
Identify the dealer with the fewest hot streaks.
Identify the oldest male dealer.
Identify the oldest female dealer.
Identify the youngest male dealer.
Identify the youngest female dealer.

Once the off-site player has located a table, the monitor displays the next screen which is the view from the overhead camera, enabling the player to monitor play in real time, while not enabling the off-site player to identify any individual player in order to select on-site player privacy. Numerical histories appear on the screen overlaying the image of the dealer which show the five most recent hands (bust-20-17-bust-20). There is an overlay of the five most recent hands (W-W-W-T-L) for each player position which is continually updated. The off-site player will know immediately the game outcome by watching the play on the screen in real time.

The off-site terminals can also be used by the casino to monitor play at each table to check for irregularities. Also, the off-site terminals may be used outside of the complex.

Speech recognition is particularly attractive for off-site play since noise levels are much easier to control. Speech recognition is also applicable for on-site play, as the dealer can wear a speech transmitter/microphone on his shirt, each play may be similarly wired, or the speakers can be inserted into the table. Sophisticated speech recognition systems are currently available from Microsoft under the trademark “Whisper.”

Speech recognition is also particularly important to monitor play, since it is a means to reduce the hardware costs of the system, and enables conventional tables to be used with only slight modification. The only hardware is an optical scanner in the card rack, a card reader, a speaker for the dealer, and a simplified keypad comprising only a card reader with exit button, and button to enable bets to be changed, and display windows for current wager and credit balance.

To enable the play of slot machines, there will be various player options. If the player wants direct play, he will participate in an electronic slot machine game directly, and will have a variety of types of games to choose from. The player is also able to play slots indirectly by piggybacking onto another player playing in real time within the casino. The advantage of the indirect play is that the player will be able to collect historical and statistical information relative to each active game from a menu. Such questions include:
Identify the hottest slot (last 50 plays).
Identify the hottest slot (last 100 plays).
Identify the hottest slot (last 200 plays).
Identify the coldest slot (last 50 plays).
Identify the coldest slot (last 100 plays).
Identify the coldest slot (last 200 plays).

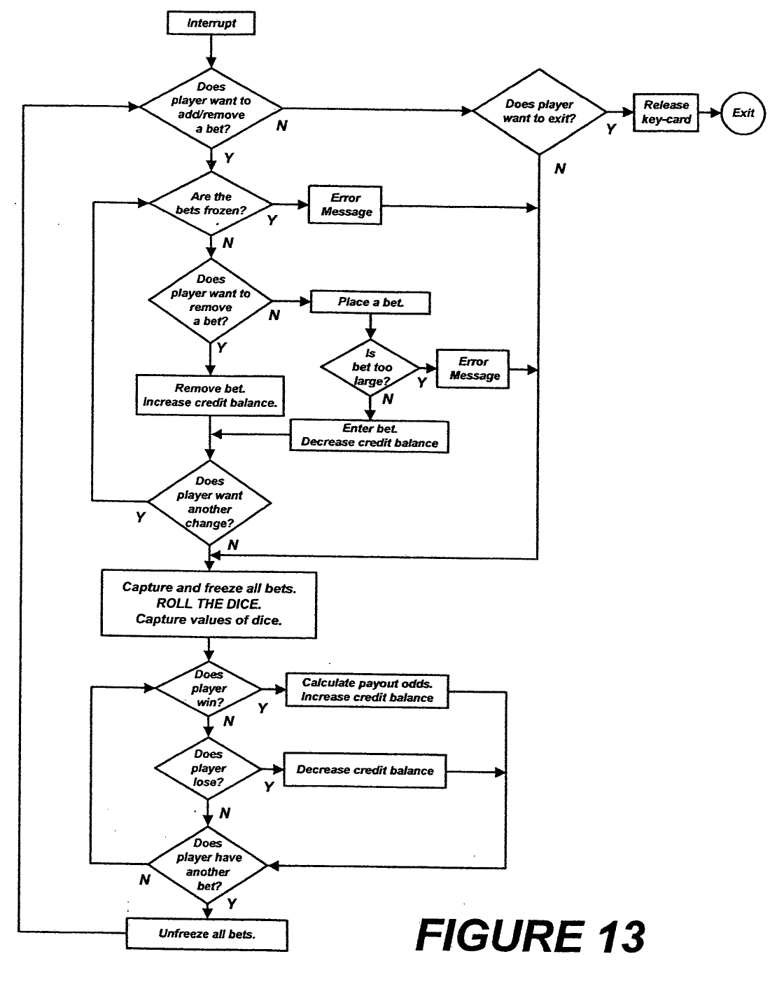

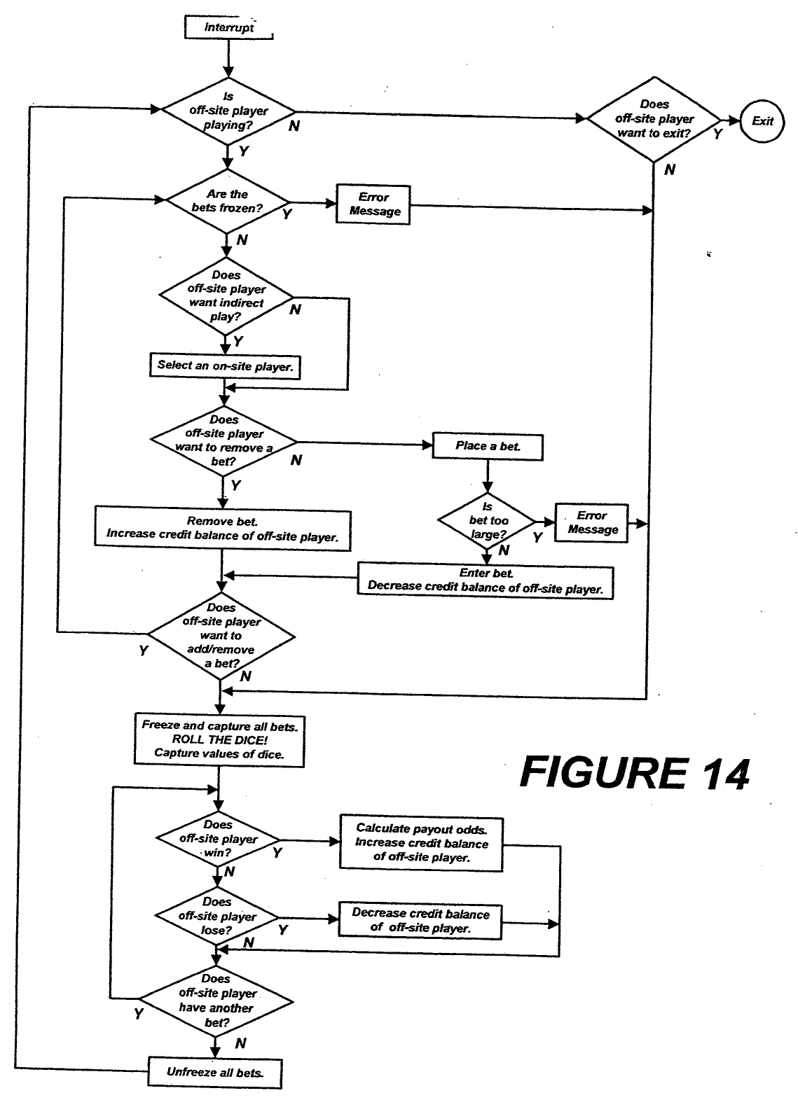

FIG. 13 shows a typical logic diagram for on-site play of craps in a gambling casino relating to the present invention, and FIG. 14 shows a similar diagram for an off-site player playing craps, the off-site player selecting an on-site player to wager with. The off-site player may wager directly on the game outcome, and in such cases, the player station is essentially identical to the on-site player station as shown in FIG. 9B.

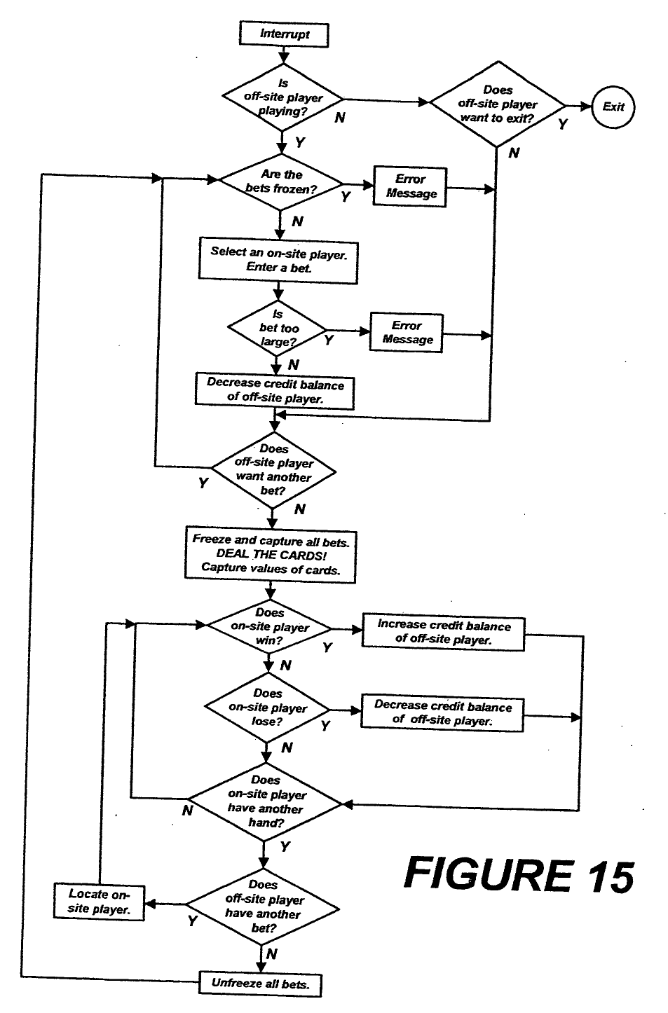

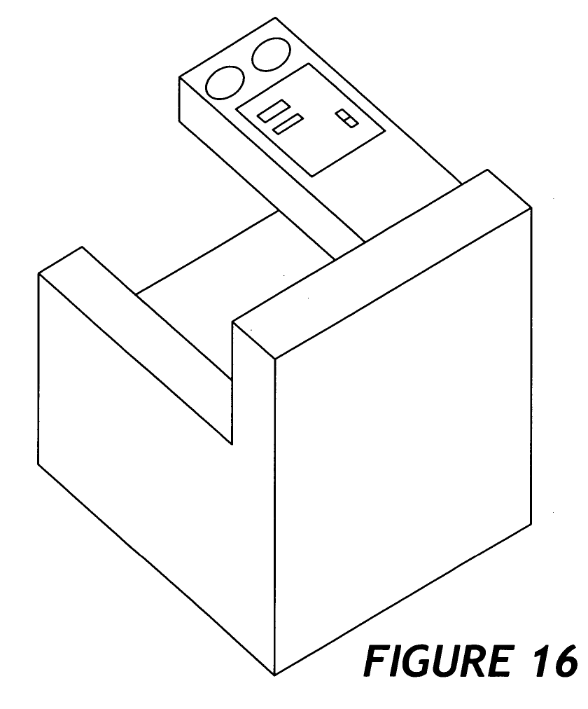

FIG. 15 is a logic diagram for an off-site player playing blackjack and wagering on the outcome of an on-site player.

The system enables an off-site player having a key-card or other credit medium to enjoy quality play at any game within the casino complex, at any time, and from any remote site connected to the system. The system of the present invention enables the off-site player to select any player in the casino and wager on the outcome of the on-site play from a remote location. In addition, in games such as craps and roulette, the off-site player has the option of wagering on the selected player or placing a direct wager on the outcome of the next gaming unit. The system of the present invention includes a live gaming site, a gaming processor, Intranet networks and Internet servers, off-site terminals, and a credit medium for use at the off-site terminals.

FIG. 16 is a depiction of an off-site terminal and player station for the casino gambling system of the present invention. The remote player station may also include a lap-top computer terminal for use in an off-site location through a hard-wired wall outlet, or through a telephone and the Internet. The lap-tops are distributed to the players upon registration or are disposed in certain preselected guest rooms.

FIG. 17A discloses the system comprising a mainframe computer and data storage for the hotel such as an IBM 360 or similar computer as required for the operation of the facility and related networks (200); a similar computer and data storage system for the casino gaming operations (201); an SNA Gateway or similar servers (203) which interconnect the mainframe computers to the facility Intranet system (202); and separate servers (204) as IBM AS400 or other units of sufficient capacity such as current 300 MHZ or better IBM compatible Pentium IIJ type servers as required for the operation of the respective Internet, Intranet, facility operations and security, financial, and gaming functions. FIG. 17E discloses remote off-site gaming locations accessed through a Wide Area Network (WAN) server (205) with T1/T3 leased lines and/or satellite communications (206) to the remote sites.

Connected to the facility Intranet (202) is:
A. The hotel mainframe (200), through a SNA Gateway or similar server (203). within which all data for the operation of the facility, guest registration and credit information is stored;
B. The hotel operations Local Area Network (207) which controls facility operations, security and registration services. The registration server (204) is interconnected to a current 300 MHZ or better IBM compatible Pentium IIJ or similar Internet gateway server (222) through which guest or player reservations are received from remote locations and all guest or player credit information is confirmed; and
C. The financial server (204) is interconnected directly to the Intranet and tracks guest or player purchases, gaming wins, losses, and payouts and enables the purchase of additional credit value to a player's account to the approved limited as requested by the guest or player (see FIG. 17B).

Gaming activities are controlled and monitored by a mainframe computer (201), such as an IBM 360. Data and remote play is accessed through the hotel Intranet (202) and SNA Gateway or similar server (203). Control of casino play is through a second SNA Gateway or similar server (203) to separate game servers (204) for each different game. All game table PC computers (208) are current 300 MHZ or better IBM compatible Pentium IIJ or similar computers and are interconnected through a separate Local Area Network for each game (209), such as blackjack, craps, KENO, or roulette. Each gaming table PC (208) receives monitor and play instruction inputs from the table scanners (210), readers (211), Television cameras (212) and other sensors (213) as required by the game, the dealer keypad (214) and optional microphone (215), and the player identification confirmation reader (216), credit control (217), interactive monitor screen (218), keypad (219) and optional microphone (215), as shown in FIG. 17C.

Off-site gaming PC-TV terminals (220) are based on current 300 MHZ or better IBM compatible Pentium IIJ or similar computers with interactive screen monitors, player identification confirmation reader (216), credit control (217), keypad (219), and optional microphone (215). Also, included in terminals located in guest rooms and selected remote off-site locations is a separate keypad (221) for enabling the guest to make purchases from products promoted on the monitors prior to and after game play or on request by the guest. Local off-site locations in guest rooms and other locations are connected to the facility Intranet (202) via the IBM AS40 or similar facility off-site Intranet server (see FIG. 17D).

Players may also access the games via the Internet and their own computers. Play to this segment is provided through a standard Internet server (204) connection and Internet service provider.

Selection of games, statistics, and play from all off-site locations is conducted through an Internet browser system. This same browser system provides instant replication of all gaming and guest/player data, real time monitoring of all games and statistics by casino management, and instant adjustment of player credit balances.

Throughout this application, various Patents and Applications are referenced by patent number and inventor. The disclosures of these Patents and Applications in their entireties are hereby incorporated by reference into this specification in order to more fully describe the state of the art to which this invention pertains.

Furthermore, it is evident that many other alternatives, modifications, and variations of the off-site gaming system of the present invention will be apparent to those skilled in the art in light of the disclosure herein. It is intended that the metes and bounds of the present invention be determined by the appended claims rather than by the language of the above specification, and that all such alternatives, modifications, and variations which form a conjointly cooperative equivalent are intended to be included within the spirit and scope of these claims.

1. A gaming system comprising:
(a) a gaming site where a casino-type game-of-blackjack is played, the casino-type game-of-blackjack being played upon a gaming table, the casino-type game-of-blackjack including individual gaming units each having a game outcome, at least one individual gaming station being disposed proximate to the gaming site;
(b) a device for capturing gaming data of the casino-type game-of-blackjack, the gaming data capture device being disposed proximate to the gaming site; and
(c) a computer for processing in real time gaming data captured by the gaming data capture device, the gaming data being accessible by an off-site player terminal that is remote from the gaming site, the computer transmitting data to the off-site player terminal upon request in real time, the computer accepting a wager submitted prior to the game outcome through the off-site player terminal upon the game outcome of the casino-type game-of-blackjack.

2. The gaming system of claim 1, wherein on-site wager activity occurs at the individual gaming stations, the computer enabling the off-site player terminal to accept a wager on the outcome of wager activity occurring at an individual gaming station.

3. The gaming system of claim 1, wherein the off-site player terminal enables player selection of a second viewing screen, the second viewing screen enabling play at a different gaming site.

4. The gaming system of claim 1, wherein the off-site player terminal enables player selection of a second viewing screen, the second viewing screen enabling off-site play of a second casino-type game-of-blackjack.

5. The gaming system of claim 1, wherein the off-site player terminal has access to historical data of previous gaming outcomes.

6. The gaming system of claim 1, wherein the computer has an Internet connection to a plurality of off-site player terminals.

7. A gaming system comprising:
(a) a gaming site where a casino-type game-of-blackjack is played, the casino-type game-of-blackjack being played upon a gaming table, the casino-type game-of-blackjack including individual gaming units each having a game outcome, at least one individual gaming station being disposed proximate to the gaming site;
(b) a device for capturing visual images of the casino-type game-of-blackjack, the gaming data capture device being disposed proximate to the gaming site; and
(c) a computer for processing in real time gaming data captured by the gaming data capture device, the gaming data being accessible for viewing by an off-site player terminal that is remote from the gaming site, the computer transmitting the visual images via an Intranet connection upon request in real time, the computer accepting a wager submitted prior to the game outcome through the off-site player terminal on the game outcome of the casino-type game-of-blackjack.

8. The gaming system of claim 7, wherein on-site wager activity occurs at the individual gaming stations, the computer enabling the off-site player terminal to accept a wager on the outcome of wager activity occurring at an individual gaming station.

9. The gaming system of claim 7, wherein the off-site player terminal enables player selection of a second viewing screen, the second viewing screen enabling play at a different gaming site.

10. The gaming system of claim 7, wherein the off-site player terminal enables player selection of a second viewing screen, the second viewing screen enabling off-site play of a second casino-type game-of-blackjack.

11. The gaming system of claim 7, wherein the off-site player terminal is compatible with a payment medium, the payment medium having an available wager balance, the available wager balance being greater than the wager.

12. The gaming system of claim 7, wherein the off-site player terminal has an Internet connection to the computer.

13. A gaming system comprising:
(a) a gaming site where a casino-type game-of-blackjack is played, the casino-type game-of-blackjack being played upon a gaming table, at least one individual gaming station being disposed proximate to the gaming site, the individual gaming station having a station game outcome for the casino-type game-of-blackjack for an individual gaming unit;
(b) a device for capturing gaming data of the casino-type game-of-blackjack, the gaming data capture device being disposed proximate to the gaming site;
(c) a computer for processing in real time gaming data captured by the gaming data capture device, the gaming data being accessible by an off-site player terminal that is remote from the gaming site, the computer transmitting data to the off-site player terminal upon request in real time, the computer providing the off-site player terminal with access to previous game outcomes, the data transmission enabling a wager to be made prior to the game outcome through the off-site player terminal on the station game outcome of the casino-type game-of-blackjack.

14. The gaming system of claim 13, wherein the gaming data capture device captures visual images of the casino-type game-of-blackjack thereby enabling a viewing of the gaming site in real time.

15. The gaming system of claim 13, wherein the off-site player terminal has an Intranet connection to the computer.

16. The gaming system of claim 13, wherein the off-site player terminal has an Internet connection to the computer.

17. The gaming system of claim 13, wherein the off-site player terminal enables player selection of a second viewing screen, the second viewing screen enabling play at a different gaming site.

18. The gaming system of claim 13, wherein the off-site player terminal enables player selection of a second viewing screen, the second viewing screen enabling off-site play of a second casino-type game-of-blackjack.

19. The gaming system of claim 13, wherein the off-site player terminal is compatible with a payment medium, the payment medium having an available wager balance, the available wager balance being greater than the wager.
